(19) United States
(12) Patent Application Publication
(10) Pub. No.: US 2024/0403080 A1
(43) Pub. Date: Dec. 5, 2024

(54) DEVICES, METHODS, AND GRAPHICAL USER INTERFACES FOR DISPLAYING VIEWS OF PHYSICAL LOCATIONS

(71) Applicant: Apple Inc., Cupertino, CA (US)

(72) Inventors: Martynas LAURITA, Santa Cruz, CA (US); Vincent P. ARROYO, Union City, CA (US); Niranjan MANJUNATH, Sunnyvale, CA (US); Stephen O. LEMAY, Palo Alto, CA (US); Peter D. ANTON, Portola Valley, CA (US); Matan STAUBER, San Francisco, CA (US); Matthew J. SUNDSTROM, Campbell, CA (US); Fiona P. O'LEARY, Palo Alto, CA (US)

(21) Appl. No.: 18/731,178

(22) Filed: May 31, 2024

Related U.S. Application Data
(60) Provisional application No. 63/506,077, filed on Jun. 3, 2023.

(51) Int. Cl. G06F 9/451; G06F 3/04815; G06T 19/00

(52) U.S. Cl. CPC G06F 9/451; G06F 3/04815; G06T 19/006

(57) ABSTRACT

In some embodiments, a computer system displays a navigation user interface within a three-dimensional environment. The navigation user interface includes one or more first travel user interface elements displayed at a first level of immersion corresponding to a first view of a first physical location, that are selectable to change the display of the navigation user interface from the first view of the first physical location to a second view of a second physical location.

### CROSS-REFERENCE TO RELATED APPLICATIONS

This application claims the benefit of U.S. Provisional Application 63/506,077, filed Jun. 3, 2023, the content of which is hereby incorporated by reference in its entirety for all its purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system presents virtual objects corresponding to physical locations within a three-dimensional environment in response to detecting user input indicating interaction with the virtual objects. In some embodiments, the computer system presents respective views of respective physical locations from different perspectives in response to detecting user input directed to the virtual objects.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7Q illustrate examples of a computer system displaying a navigation user interface with a respective level of immersion corresponding to a respective view of a respective physical location in accordance with some embodiments.

FIG. 8 is a flowchart illustrating an exemplary method of displaying a navigation user interface with a respective level of immersion corresponding to a respective view of a respective physical location in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays a navigation user interface within a three-dimensional environment. The navigation user interface includes one or more first travel user interface elements displayed at a first level of immersion corresponding to a first view of a first physical location. In some embodiments, while displaying the navigation user interface including the one or more first travel user interface elements, the computer system detects a first input corresponding to a request to change a level of immersion. In response to the detecting the first input, the computer system changes the display of the navigation user interface with the first level of immersion corresponding to the first view of the first physical location to a second level of immersion corresponding to the first view of the first physical location. The second level of immersion includes one or more second travel user interface elements, different from the one or more first travel user interface elements, that are selectable to change the display of the navigation user interface from the first view of the first physical location to a second view of a second physical location.

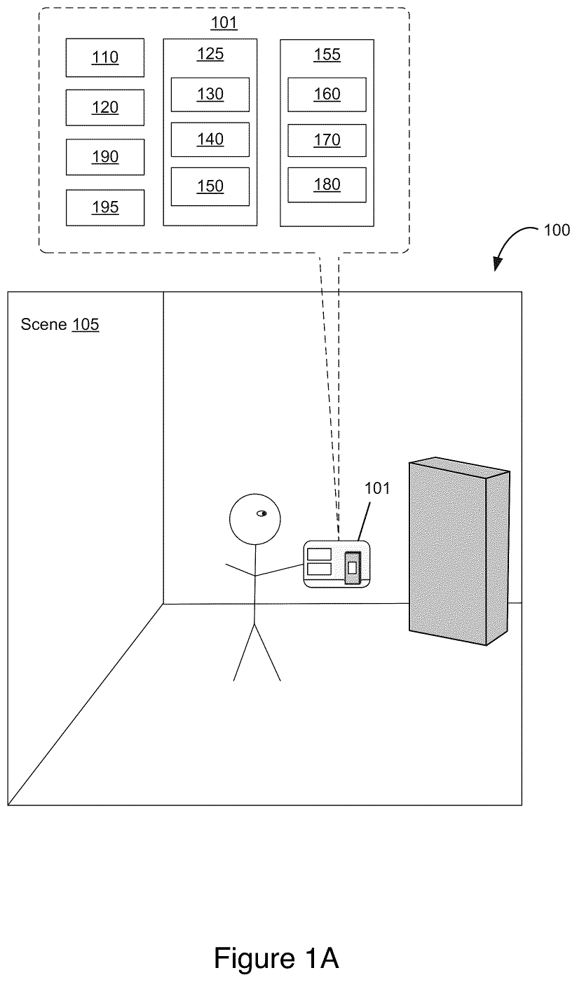

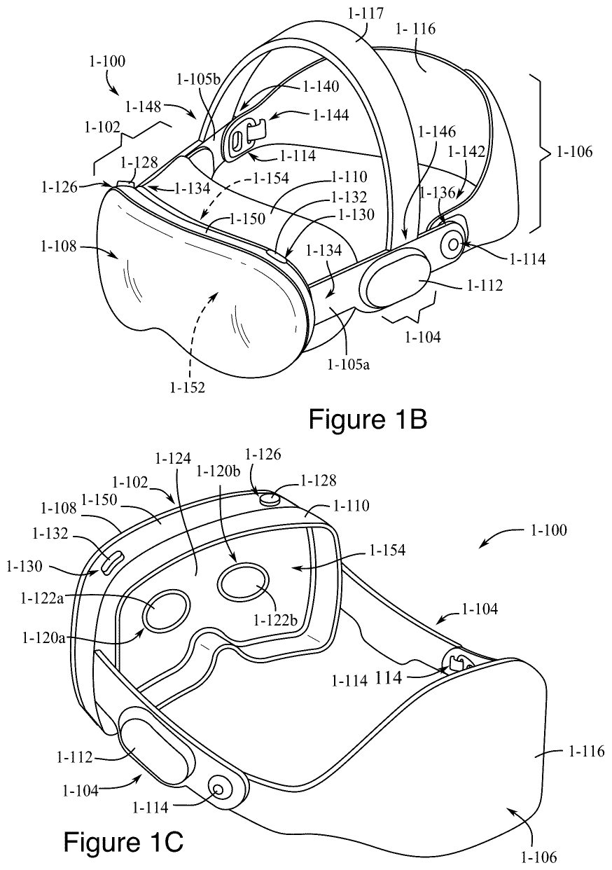

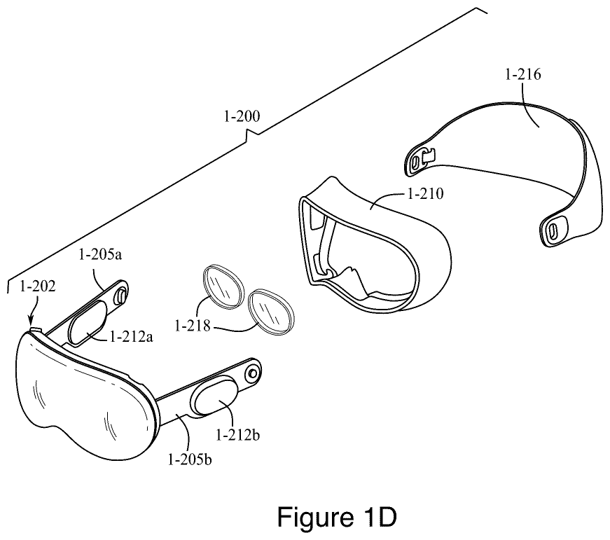

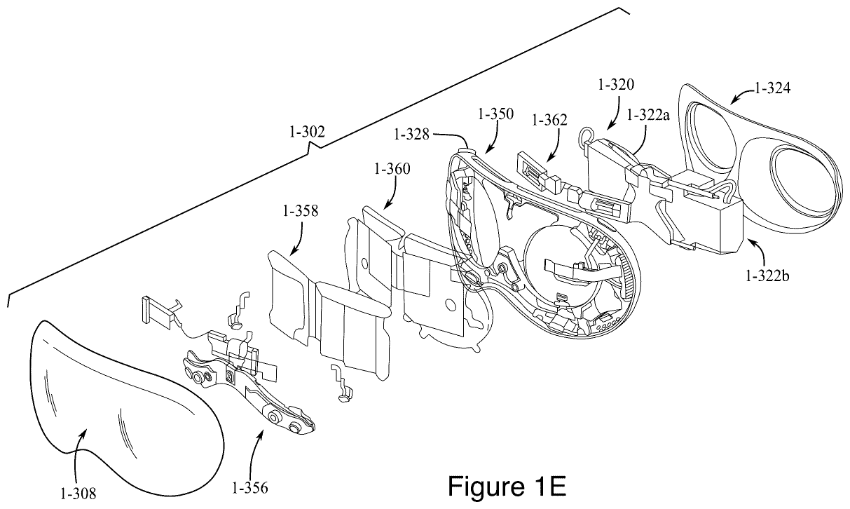

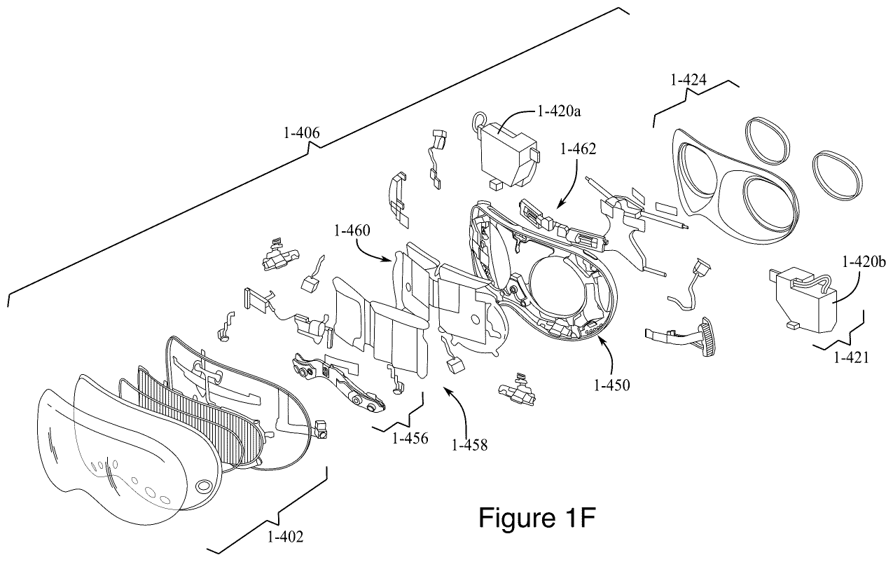

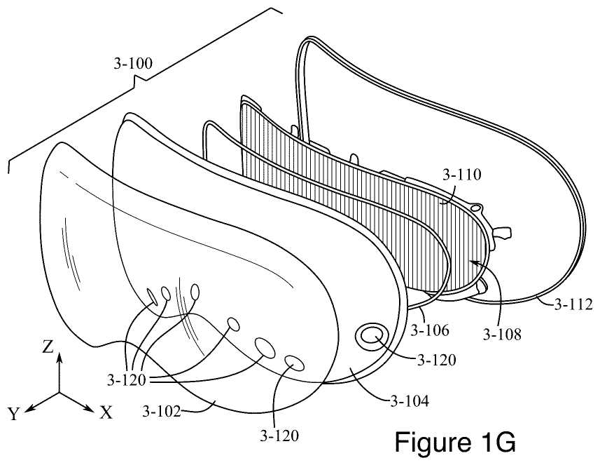

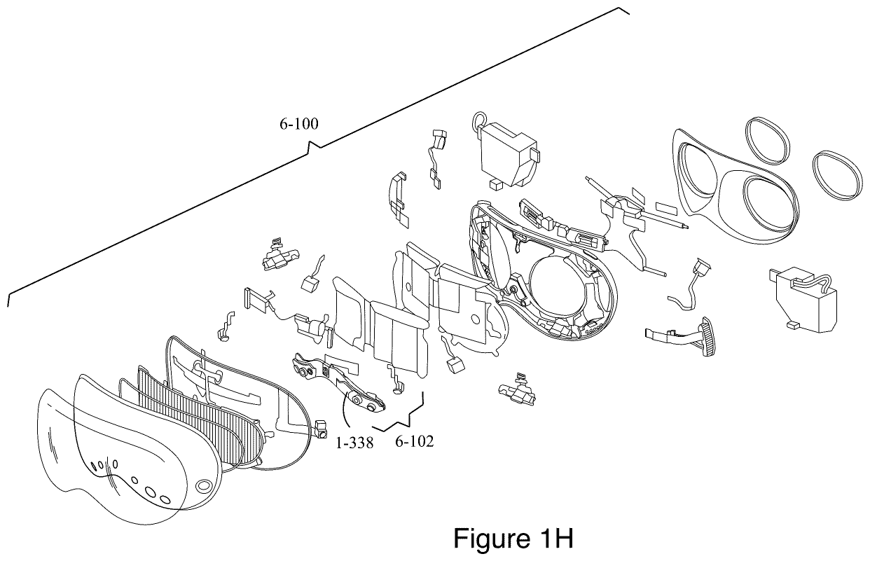

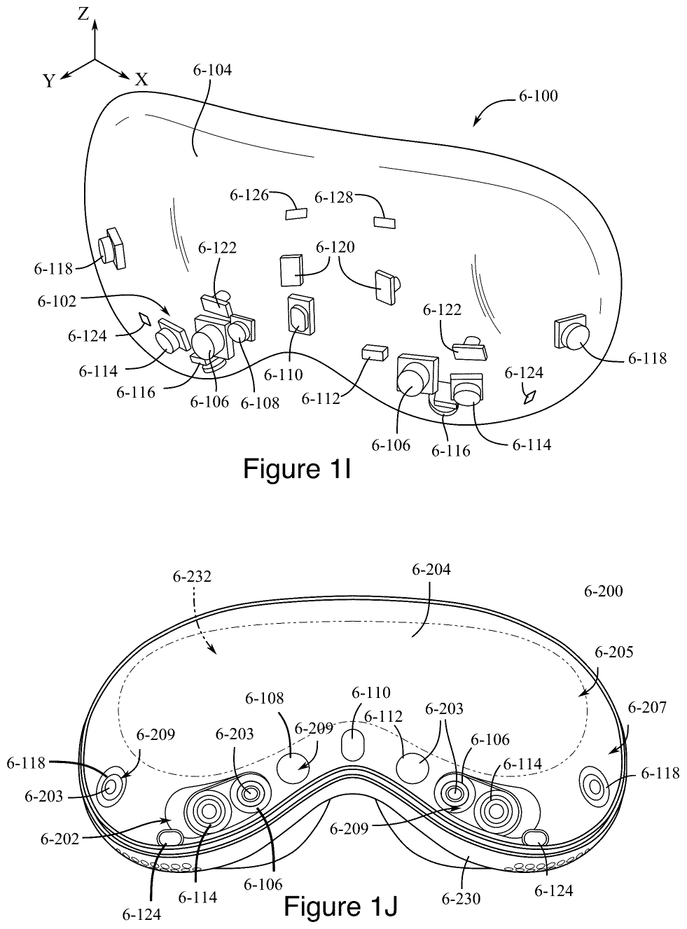

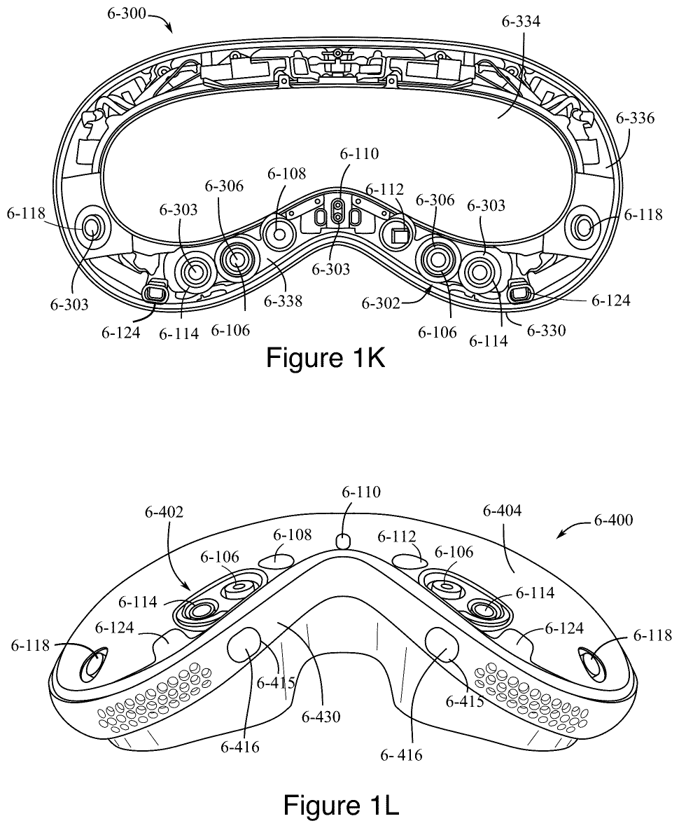

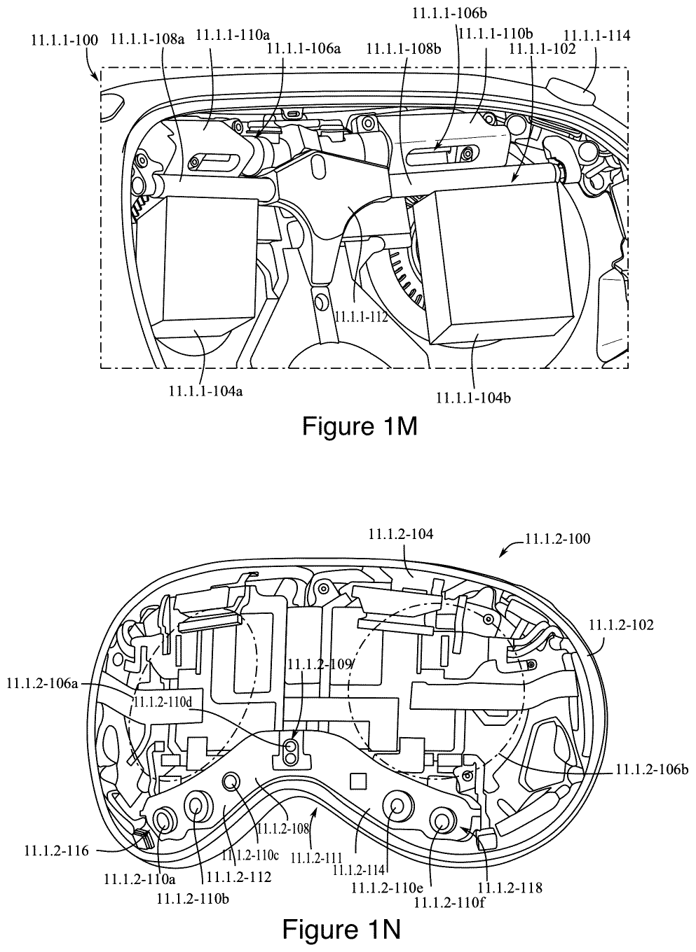

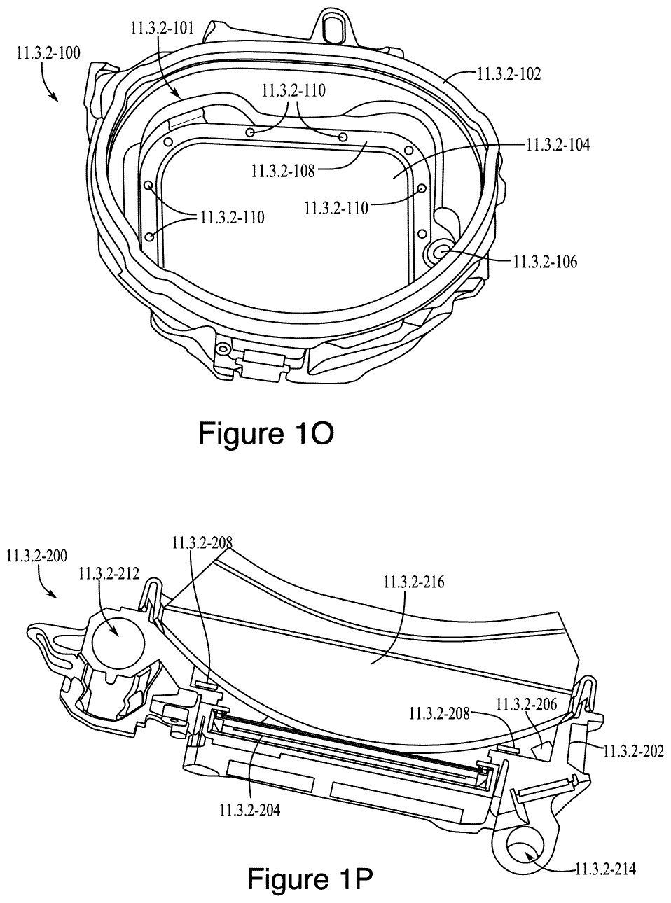

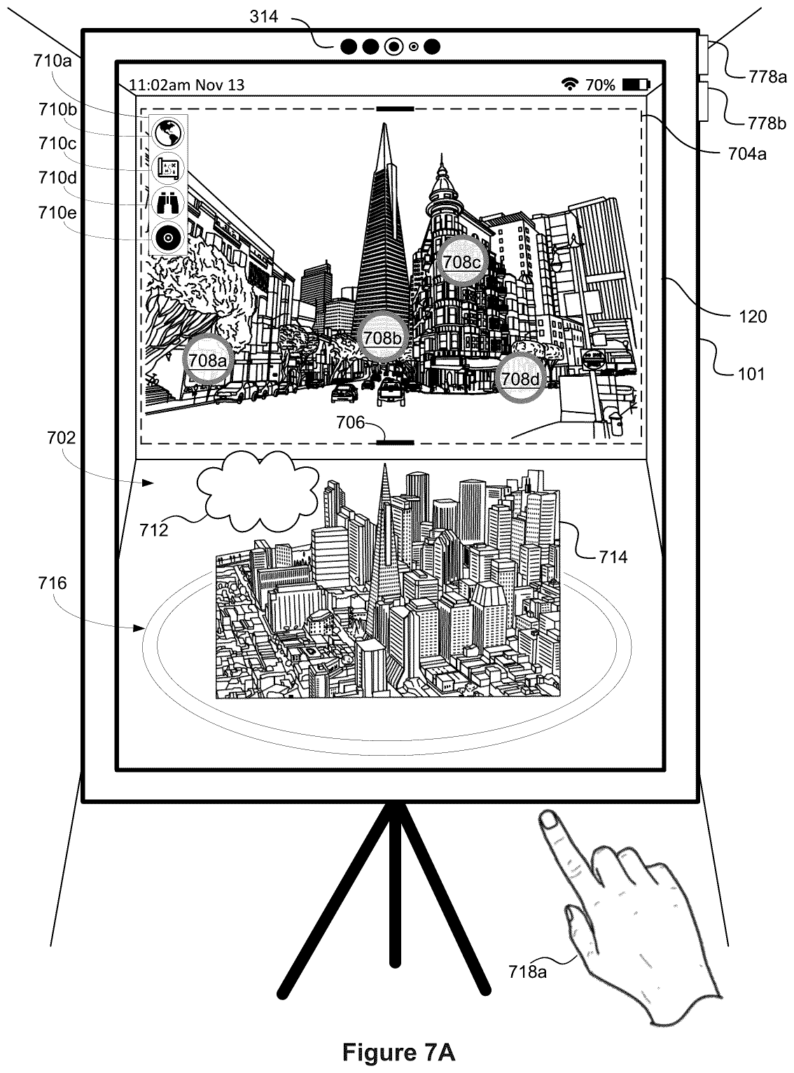

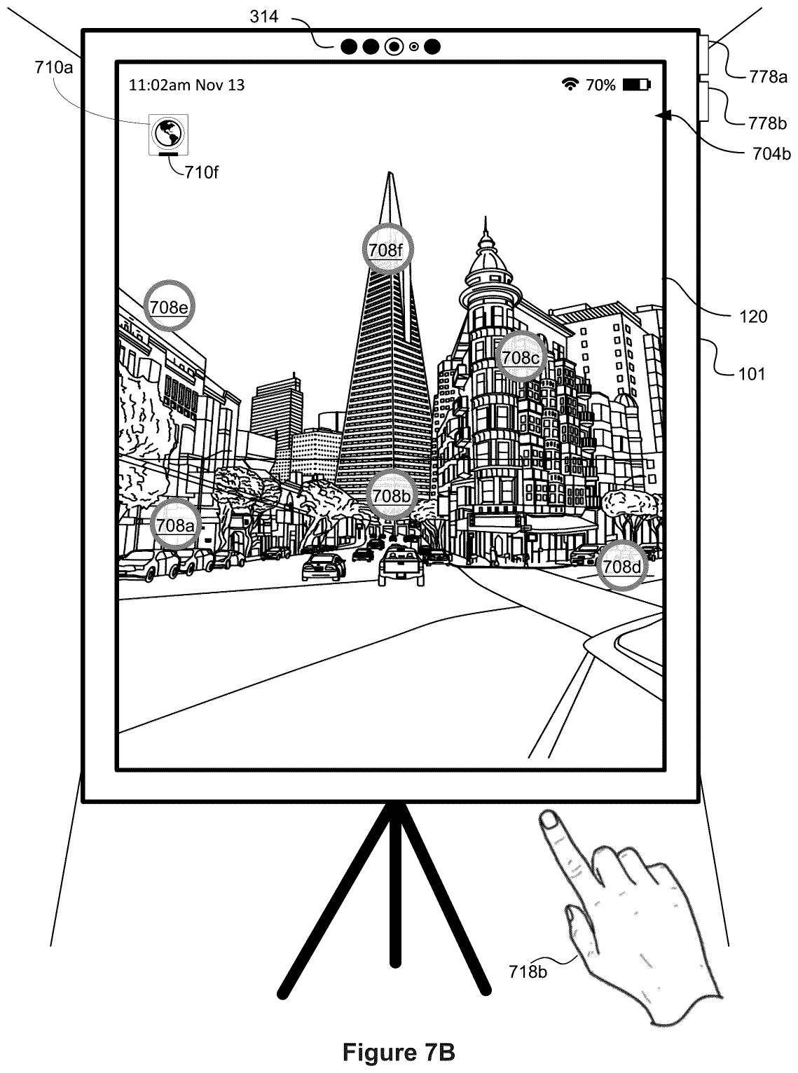

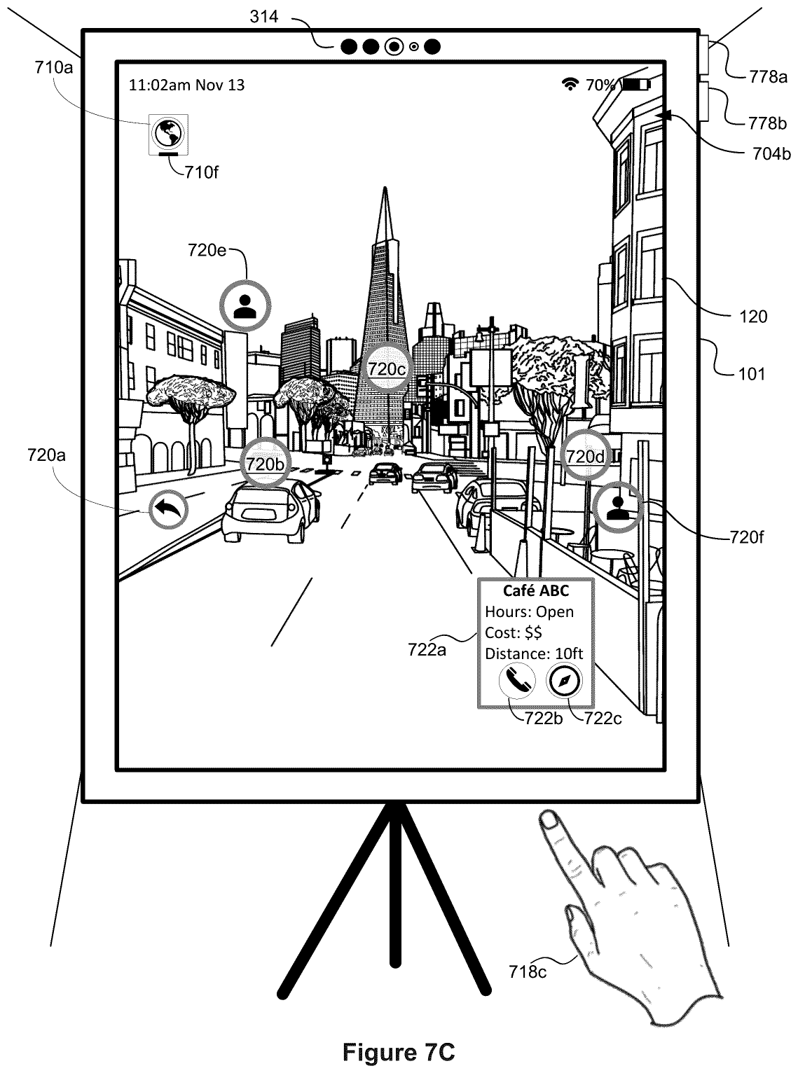

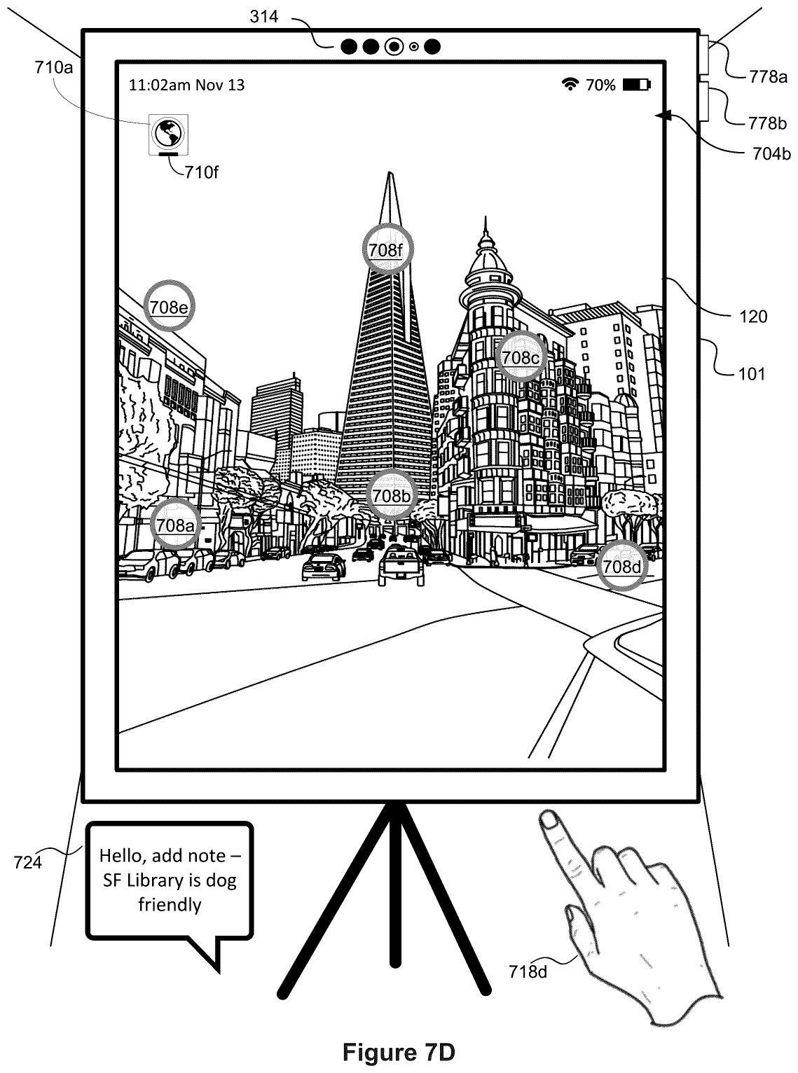

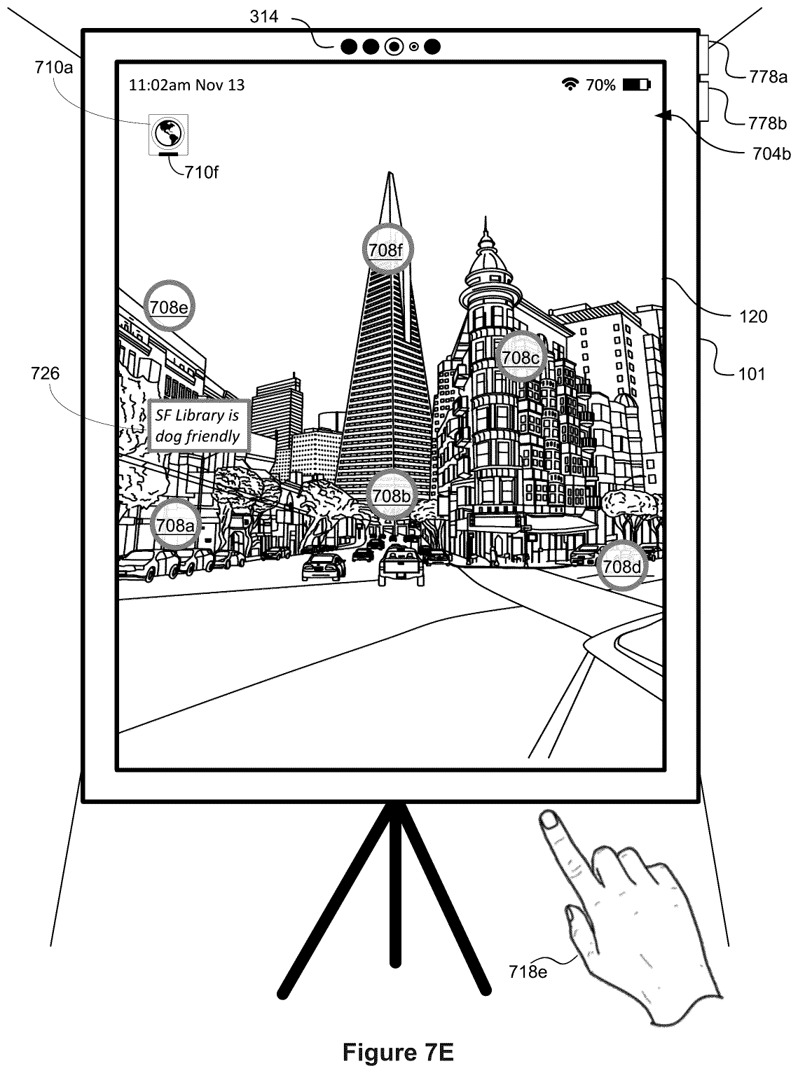

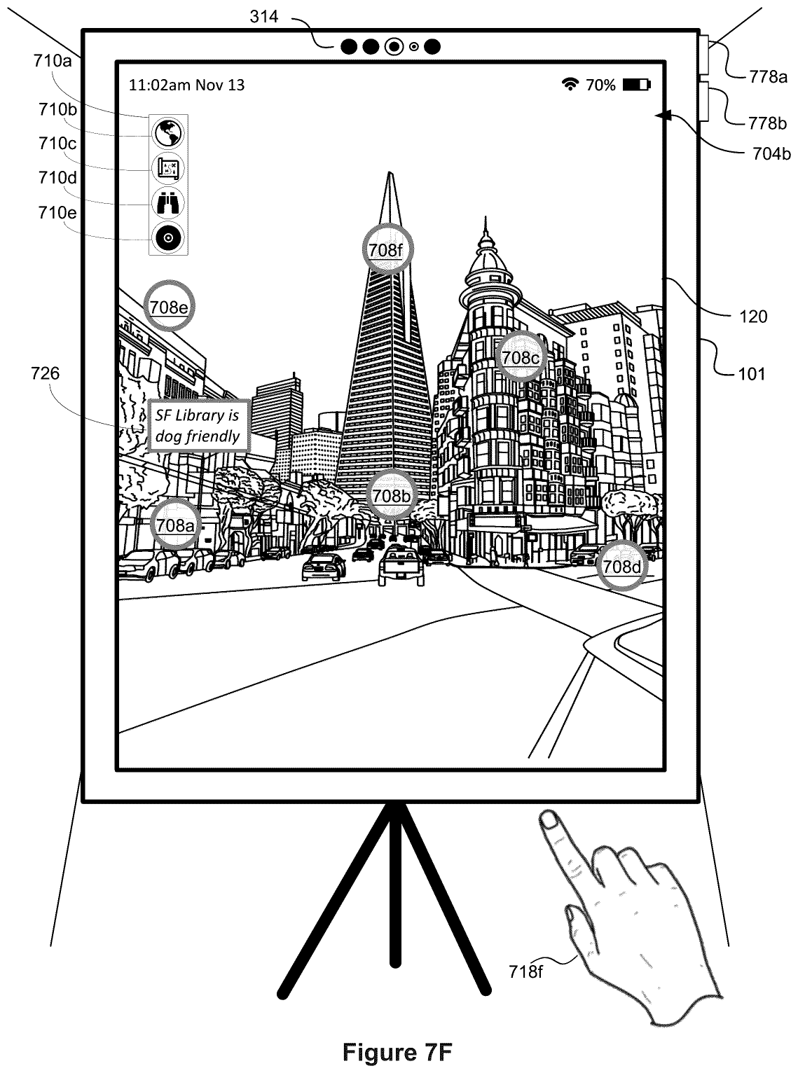

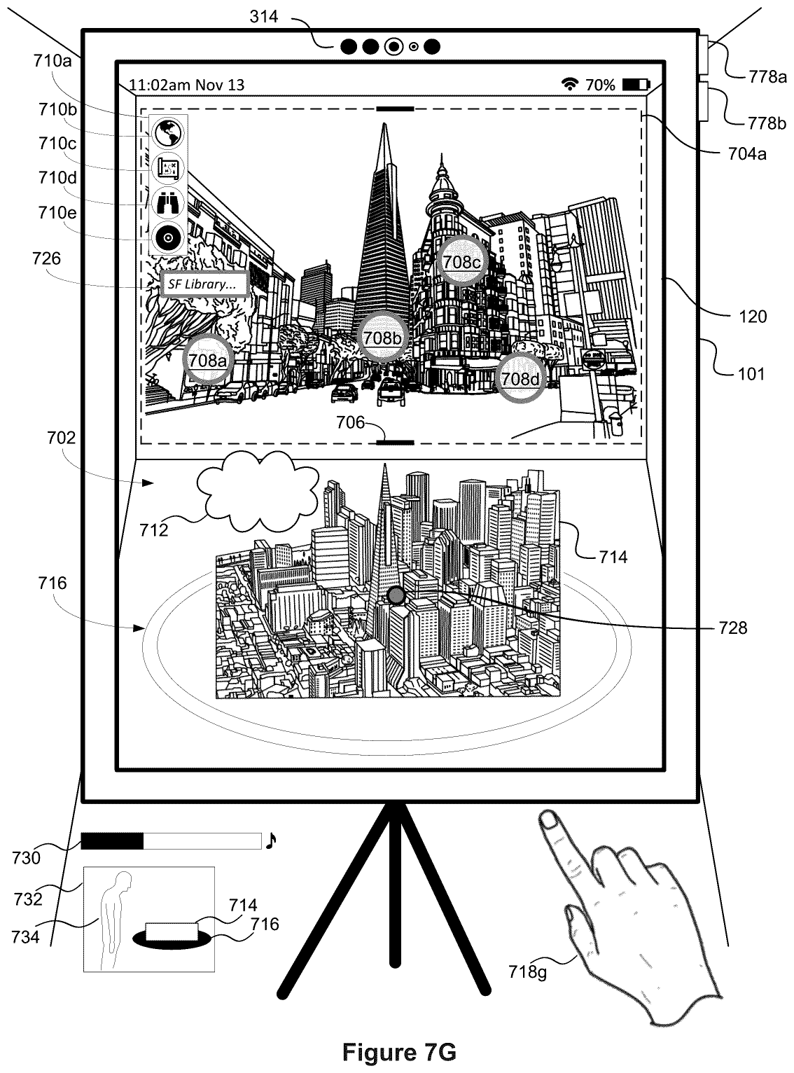

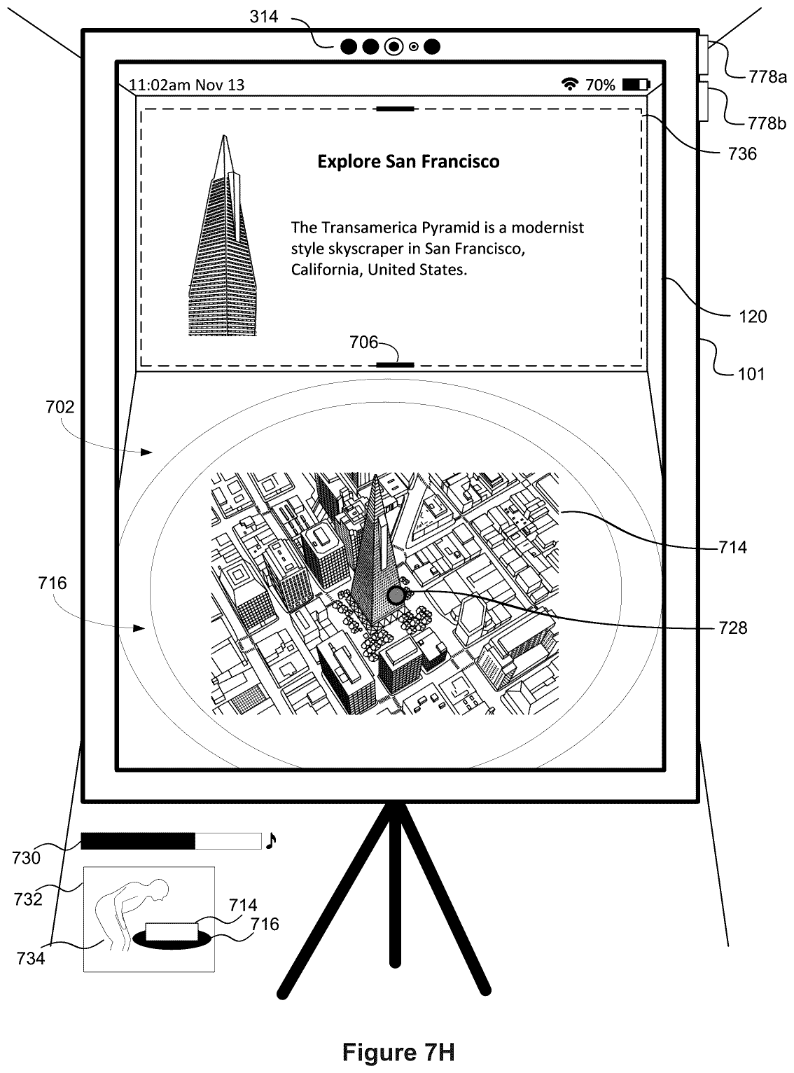

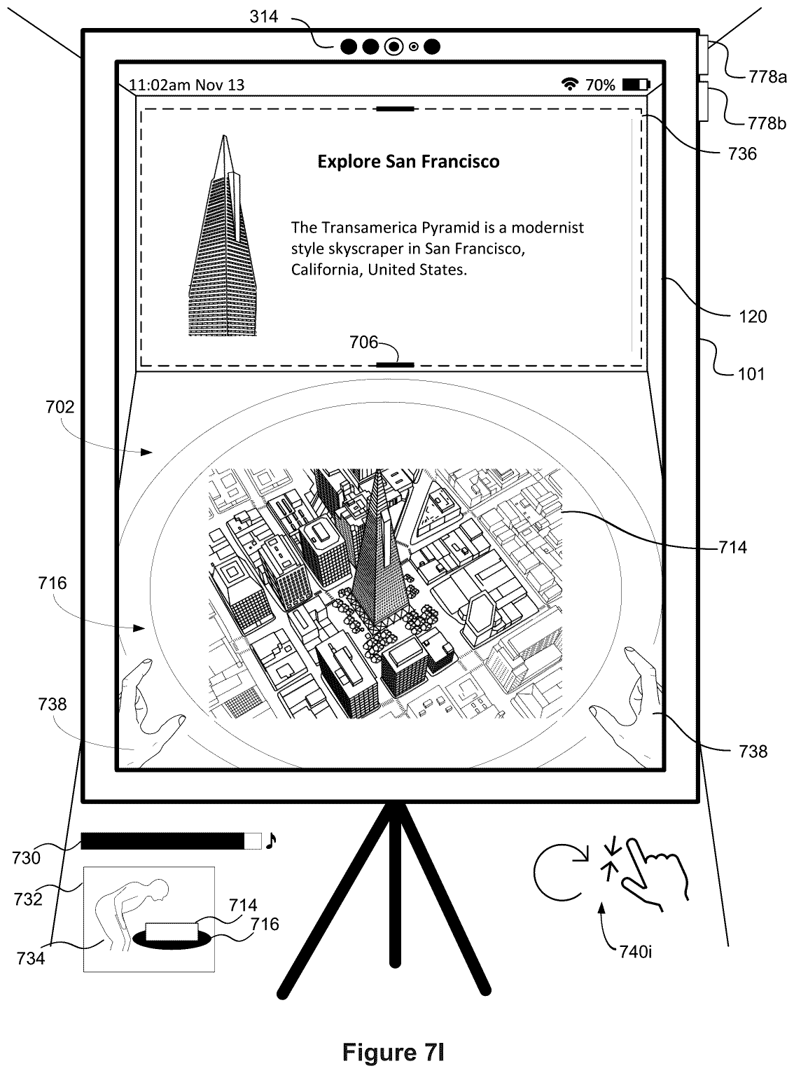

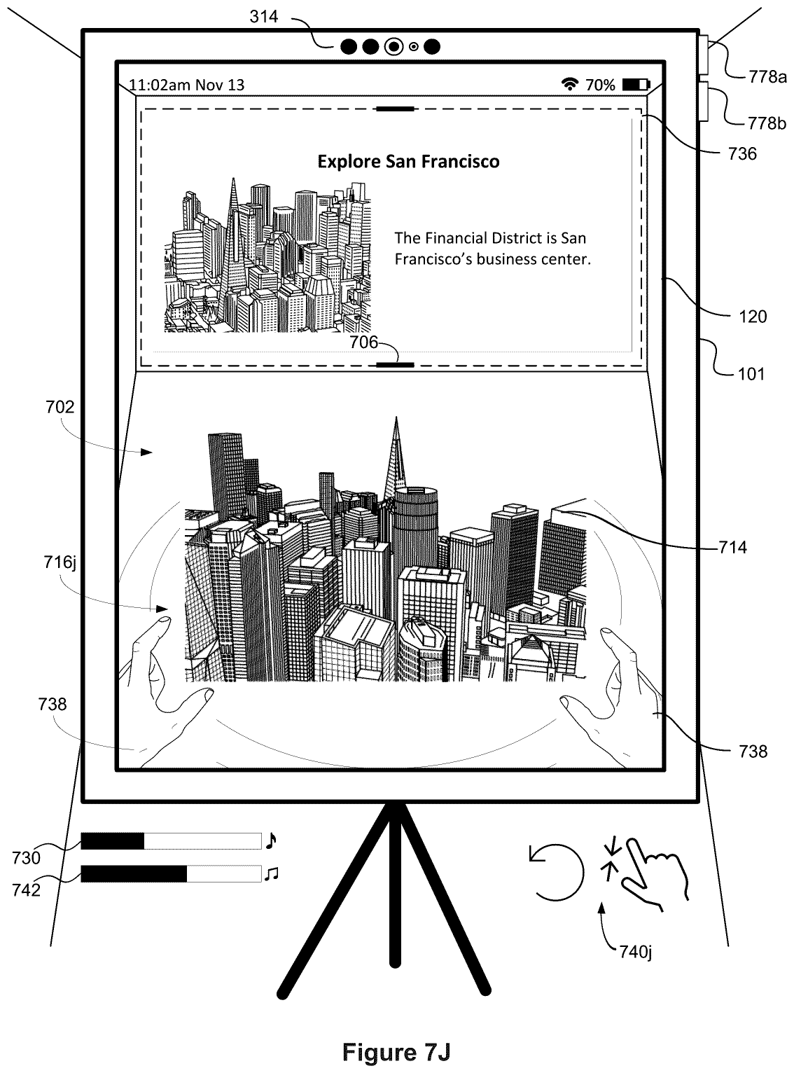

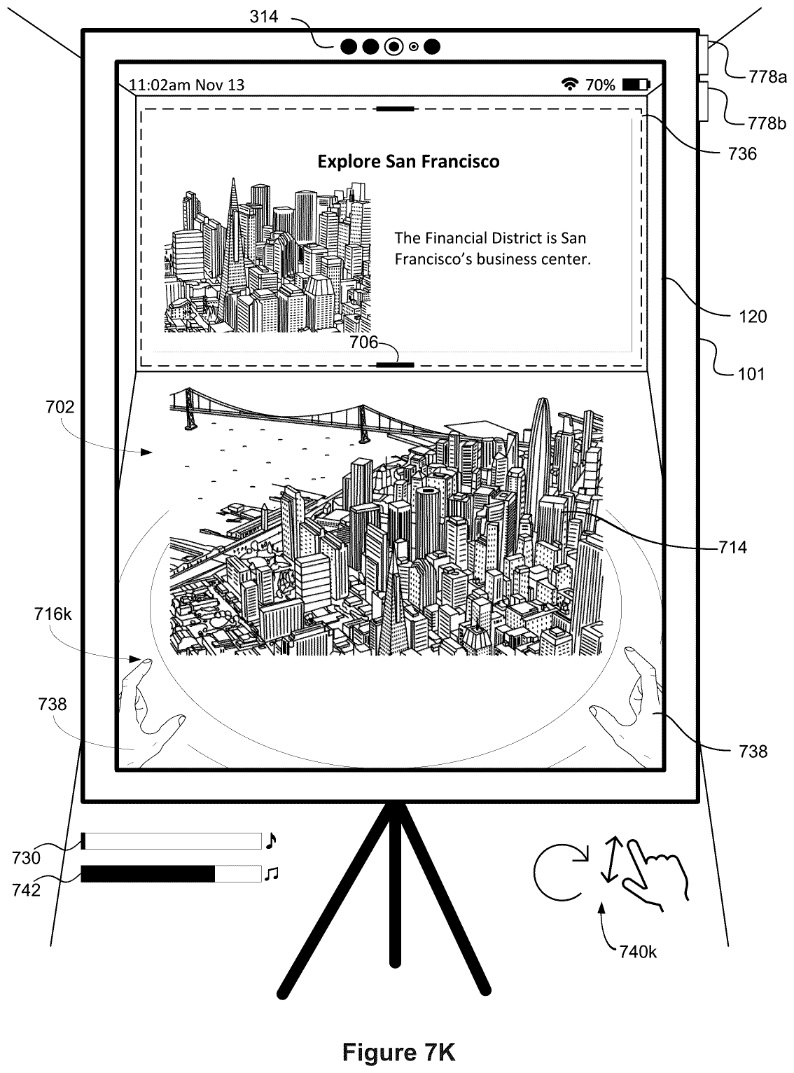

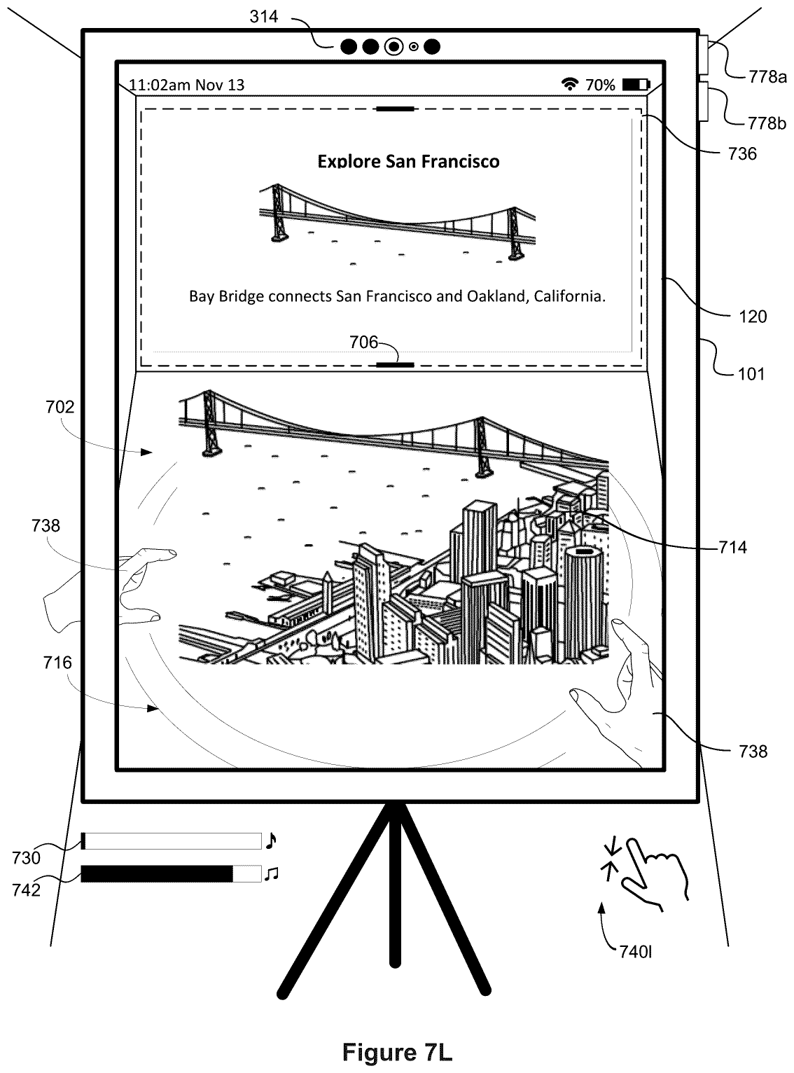

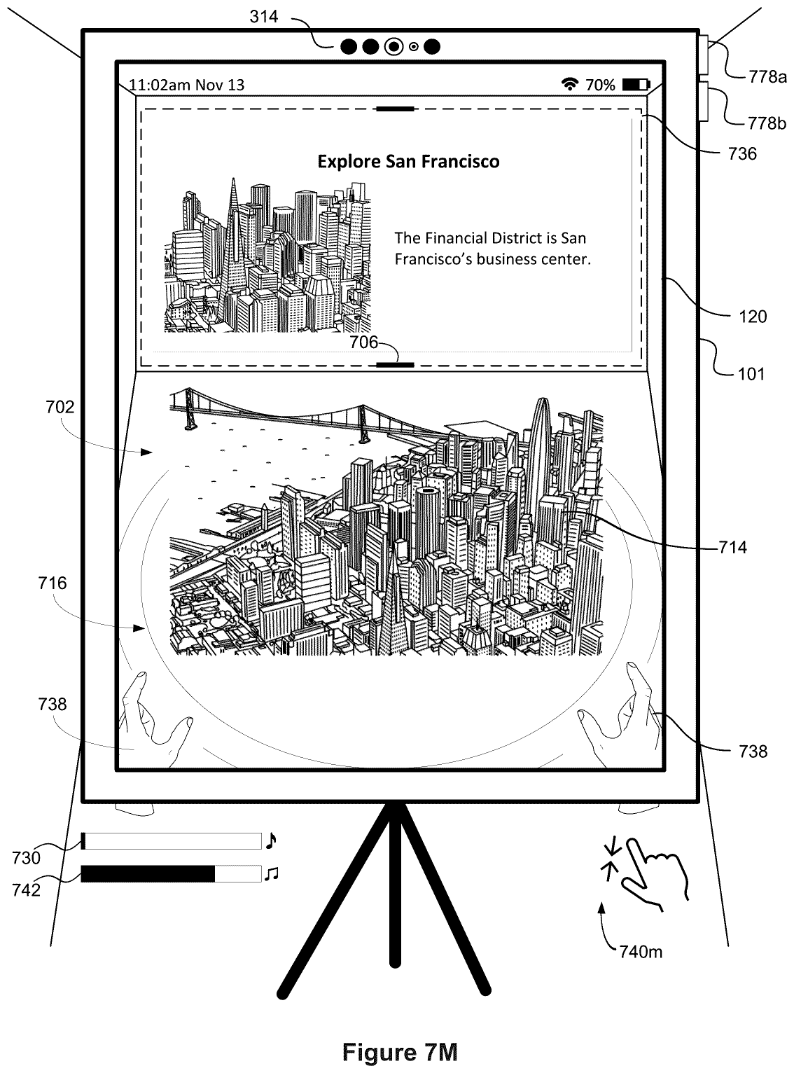

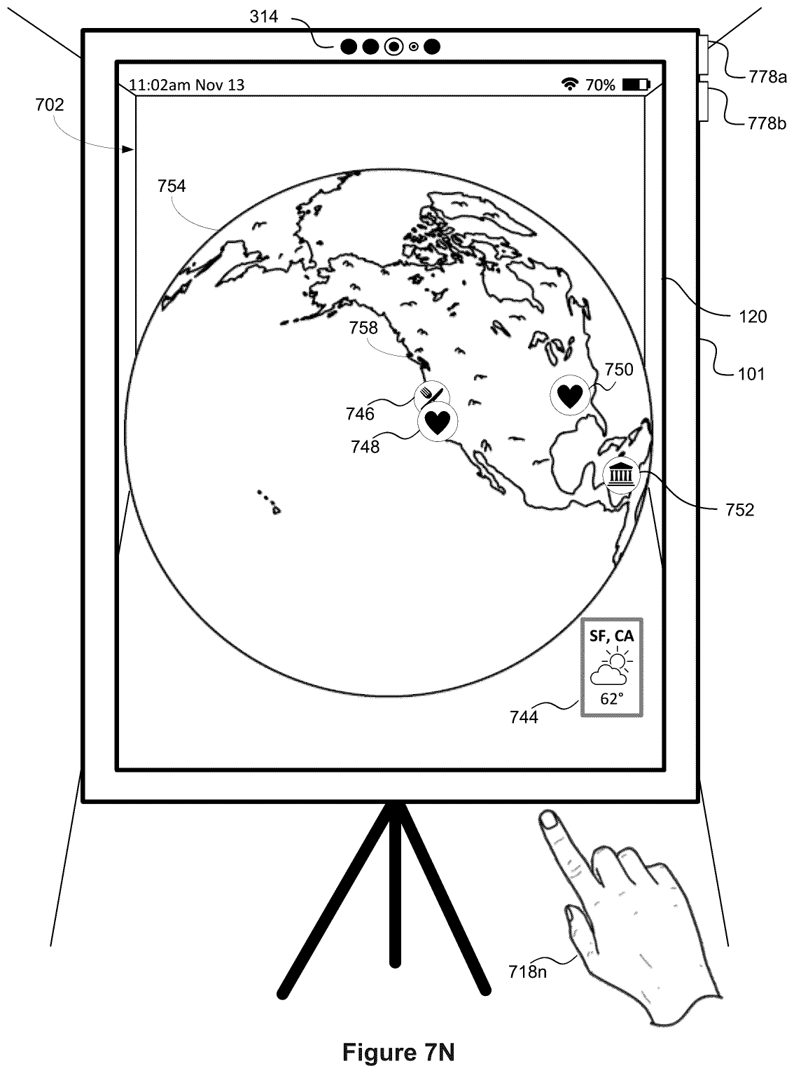

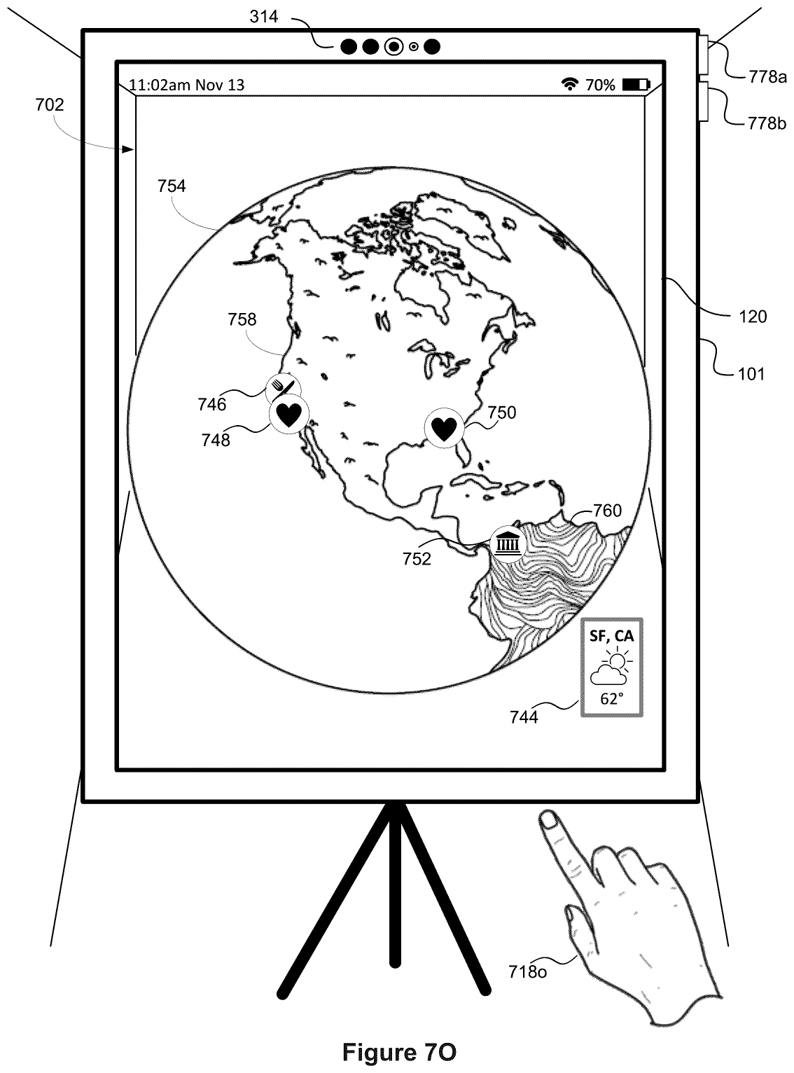

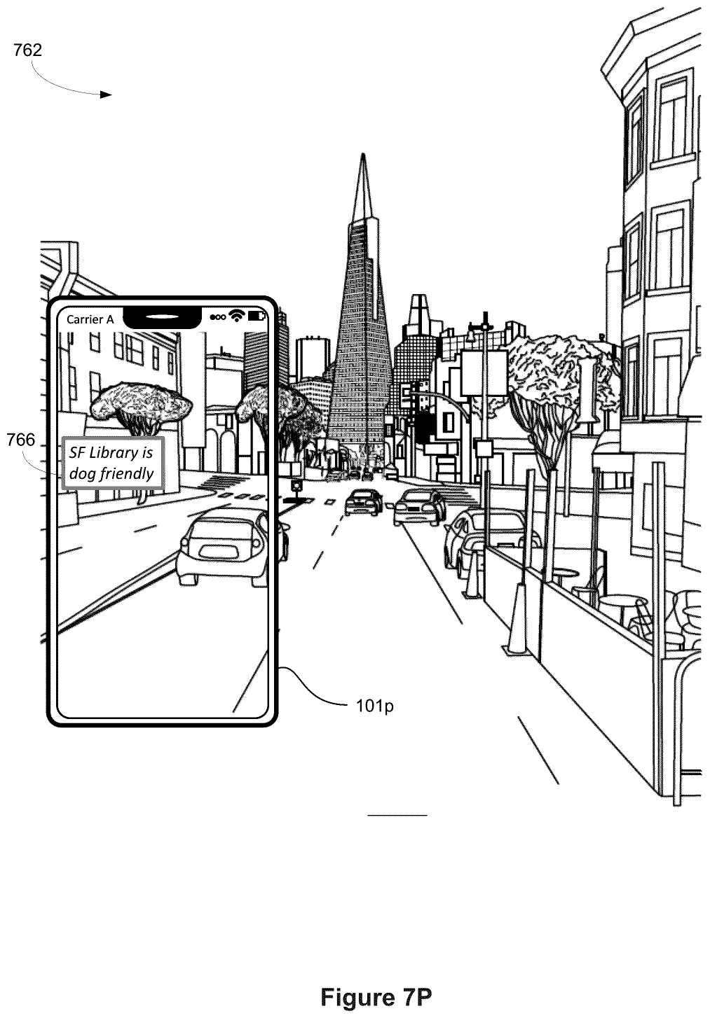

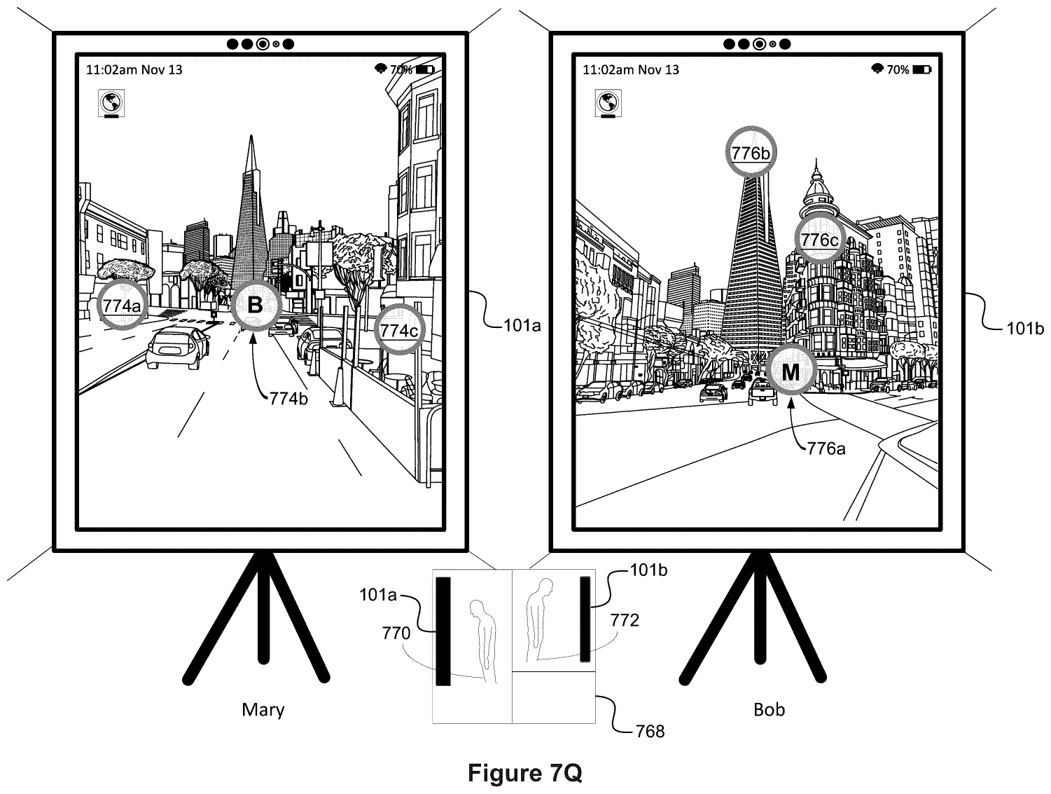

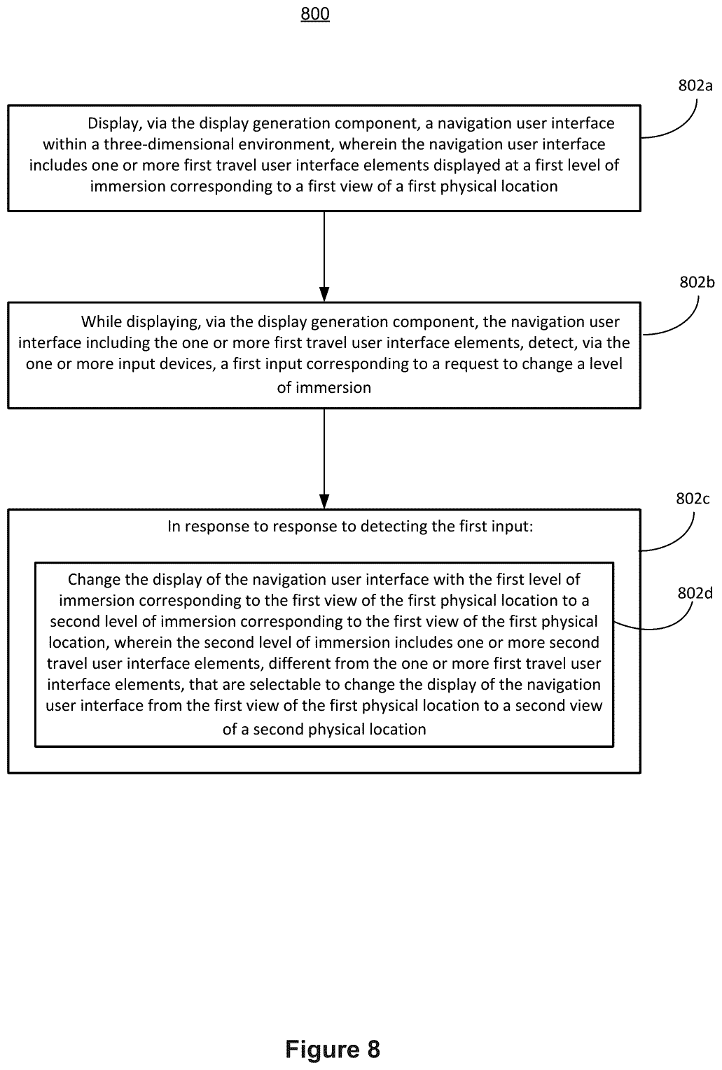

FIGS. 1-6 provide a description of example computer systems for providing XR experiences to users (such as described below with respect to method 800). FIGS. 7A-7Q illustrate examples techniques for displaying a navigation user interface with a respective level of immersion corresponding to a respective view of a respective physical location in accordance with some embodiments. FIG. 8 depicts a flow diagram of an exemplary method of displaying a navigation user interface with a respective level of immersion corresponding to a respective view of a respective physical location in accordance with some embodiments.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a×R system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

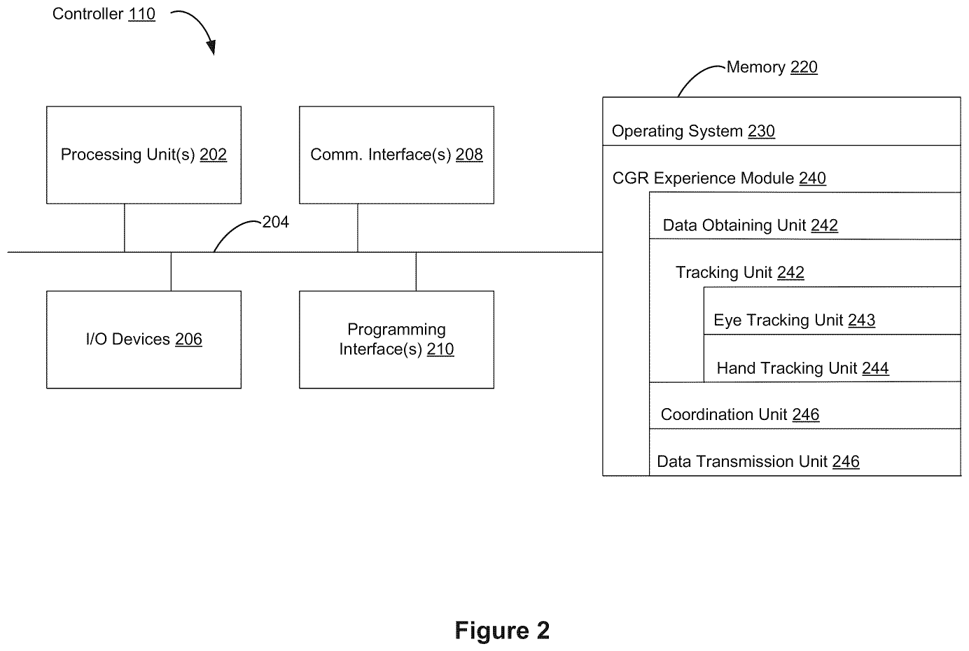

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

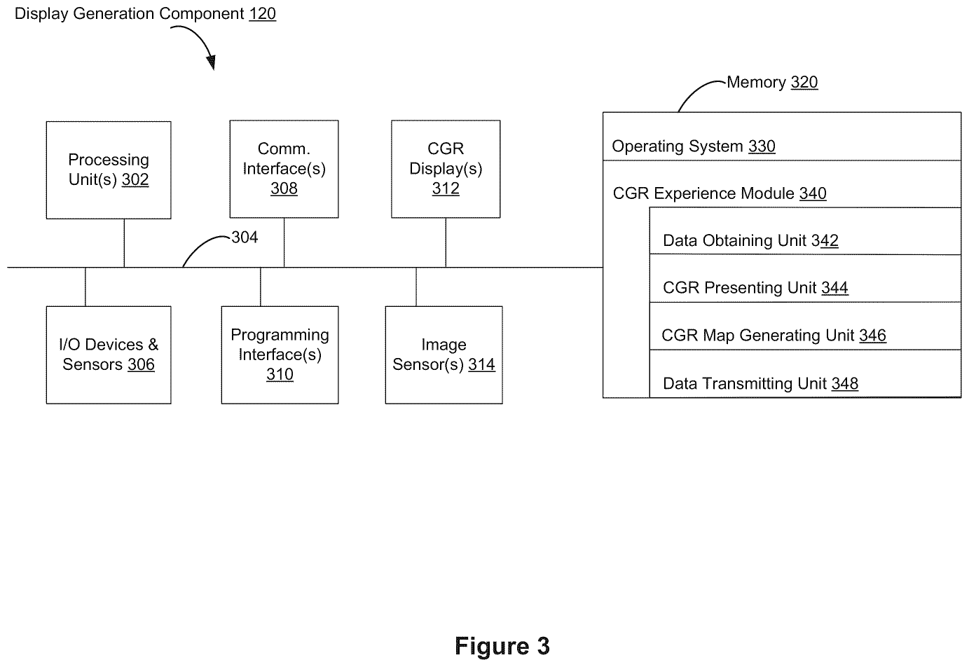

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIG. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMID device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIG. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

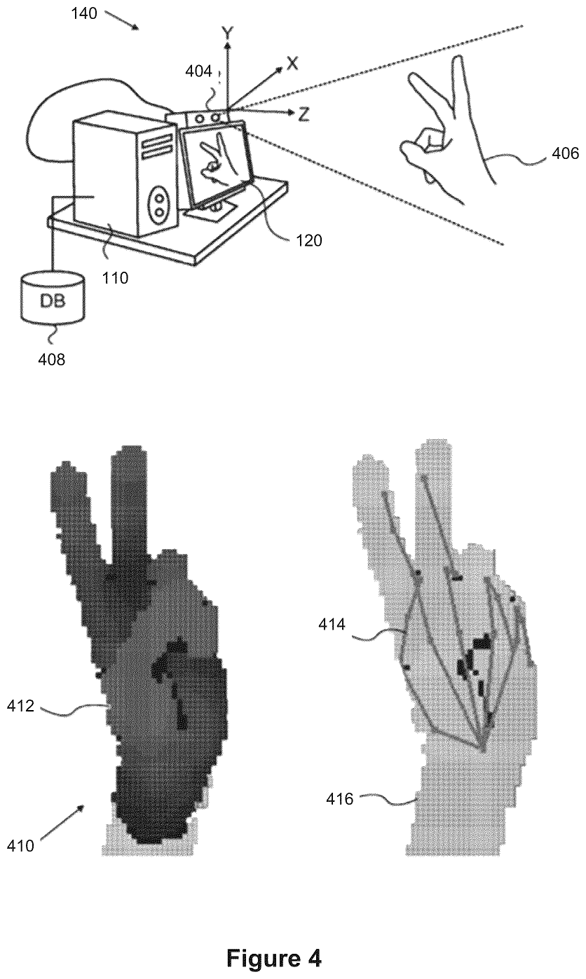

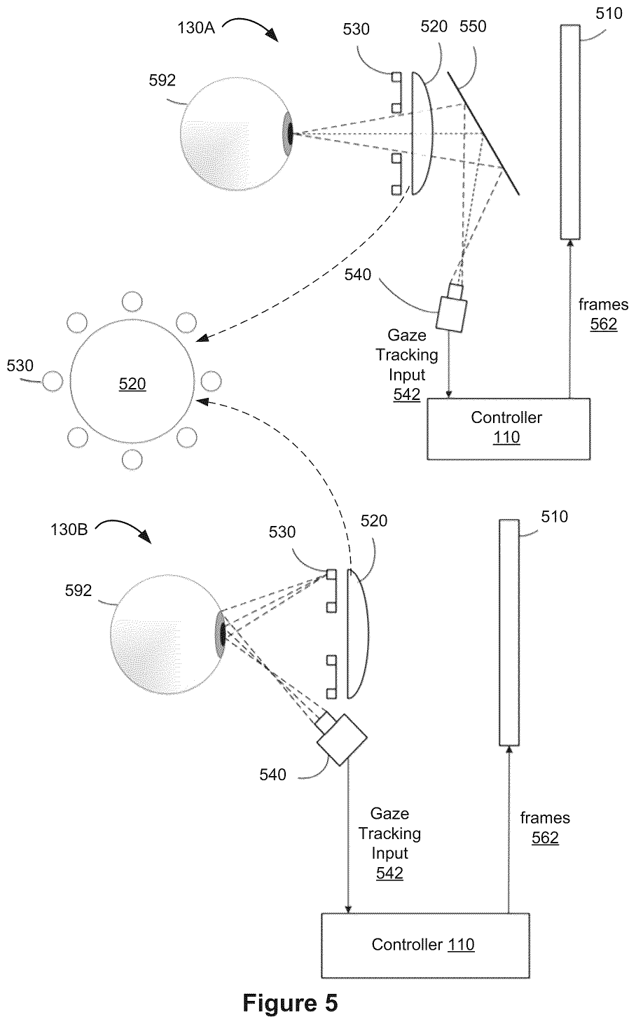

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

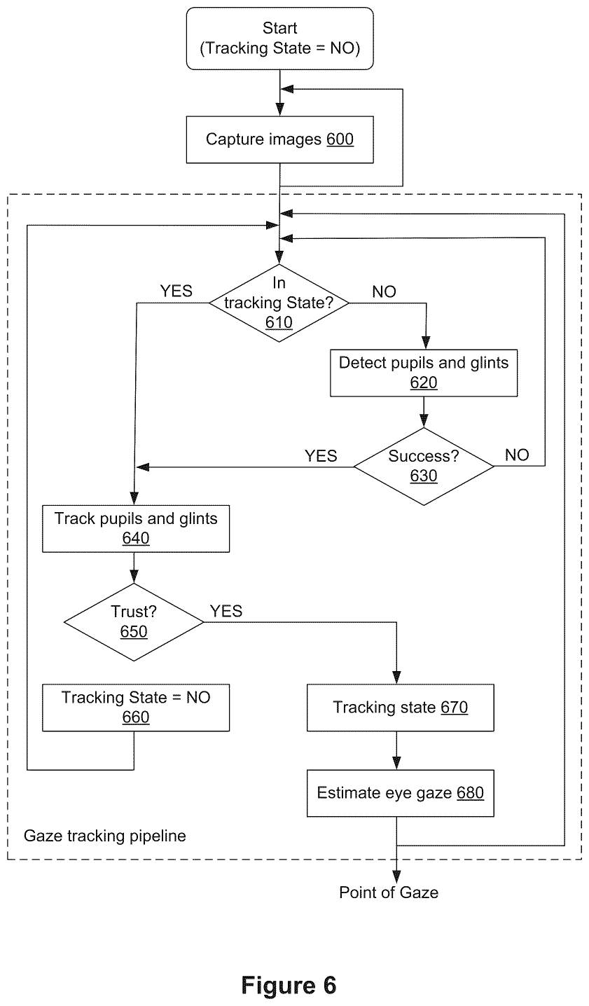

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

In some embodiments, a computer system presents virtual objects corresponding to physical locations within a three-dimensional environment. The virtual objects described below include images and/o video taken from and/or of the physical locations. In some embodiments, the virtual objects provide respective views of respective physical locations from different perspectives without the need for subsequent inputs to manipulate (e.g., rotate, pan, and/or zoom in or out) a map, thus enabling a user to easily view and experience physical locations from a variety of perspectives. Enhancing interactions with a computer system reduces the amount of time needed by a user to perform operations, and thus reduces the power usage of the computer system and increases battery life for battery-powered computer system.

FIGS. 7A-7Q illustrate examples of a computer system updating a display of a navigation user interface including travel user interface elements and/or one or more navigation user interface elements based on a level of immersion in accordance with some embodiments. In some embodiments, the travel user interface elements are selectable to update the display of the navigation user interface with a respective level of immersion corresponding to a respective view of a respective physical location in accordance with some embodiments.

FIG. 7A illustrates a computer system 101 displaying, via a display generation component (e.g., display generation component 120 of FIG. 1), a three-dimensional environment 702 from a viewpoint of a user. As described above with reference to FIGS. 1-6, the computer system 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user).

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 702 or portions of the physical environment are visible via the display generation component 120 of computer system 101. For example, three-dimensional environment 2302 includes portions of the left and back walls, and the floor in the physical environment of the user.

In FIG. 7A, three-dimensional environment 702 also includes virtual objects, such as virtual objects 704a and 714. Virtual objects 704a and 714 are optionally one or more of a user interface of an application (e.g., navigation user interface of a map application), a three-dimensional object (e.g., virtual volumetric map element of the navigation user interface), or any other element displayed by computer system 101 that is not included in the physical environment of computer system 101. In some embodiments, virtual object 704a is a navigation user interface that includes virtual content and/or imagery (e.g., captured photos and/or video) associated with various geographical locations, points of interest, etc. For example, the computer system 101 displays navigation user interface 704a partially immersive corresponding to a respective view of a respective physical location. Navigation user interface 704a also includes selectable travel user interface objects 708a, 708b, 708c, and 708d that, when selected, cause the computer system 101 to display content having a different respective view of the same respective physical location or a different physical location as will be described below. Navigation user interface 704a also includes selectable user interface element 706 that, when selected, causes the computer system to increase or decrease a size of the navigation user interface 604a. Navigation user interface 704a also includes selectable user interface element 710a that includes selectable navigation user interface objects 710b, 710c, 710d, and 710e that, when selected, causes the computer system 101 to display navigation user interface elements associated with the respective physical location as will be described below. In some embodiments, and as will be described below, physical buttons 778a and 778b of the computer system 101 change the level of immersion of the navigation user interface 704a in response to manipulation of physical buttons 778a and/or 778b.

In FIG. 7A, the computer system 101 displays navigation user interface element 714 which includes representations of physical objects (e.g., buildings, landmarks, buildings, landmarks, parks, and/or lanes of roads, trees). The navigation user interface element 714 also includes an indication 712 (e.g., a cloud) of weather at the respective physical location that corresponds to a physical location experiencing the weather represented by indication 712 (e.g., cloudy weather). The navigation user interface element 714 further includes a selectable user interface control element 716, that when selected (optionally by hand 718a), causes the computer system to adjust the position and/or orientation of navigation user interface element 714 as will be described below.

In some embodiments, the computer system displays the navigation user interface 704a with a different level of immersion as described herein with respect to presenting varying levels of immersion in which VR and/or AR content occupies larger or smaller portions of the three-dimensional environment 702 relative to content corresponding to the physical environment of the computer system 101 (e.g., passthrough video). For example, the computer system detects user input (e.g., finger of hand 718a touching physical buttons 778a and/or 778b). Additionally or alternatively, the computer system detects user input (e.g., finger of hand 718a touching a trackpad, an air pinch gesture and/or air tap gesture from hand 718a) while optionally attention/gaze of the user of the computer system 101 is directed to a settings menu user interface element for changing the level of immersion. For example, in response to the computer system detecting a user input as described herein, such as input directed to the setting menu user interface element or input to manipulate physical buttons 778a and/or 778b, the computer system changes the level of immersion. In some embodiments, computer system 101 detects other types of user inputs directed to selectable user interface element 706, such as via an input device in communication with computer system 101 and/or voice input from the user.

In response to hand 718a manipulating physical buttons 778a and/or 778b, the computer system changes the level of immersion in which the navigation user interface 704a occupies larger or smaller portions of the three-dimensional environment 702 relative to content corresponding to the physical environment of the computer system 101. For example, in response to the computer system detecting user input directed to a setting menu user interface element for changing the level of immersion or input to manipulate physical buttons 778a and/or 778b, the computer changes the display of the navigation user interface 704a as partially immersive (e.g., with a first level of immersion) corresponding to a respective view of a respective physical location as shown in FIG. 7A to displaying the navigation user interface 704b as fully immersive (e.g., with a second level of immersion) corresponding to the respective view of the respective physical location as shown in FIG. 7B. As shown in FIG. 7B, navigation user interface 704b includes virtual content that covers the entirety of the three-dimensional environment compared to when the computer system displayed the navigation user interface 704a as partially immersive. In some embodiments, navigation user interface 704b includes a collapsed view of selectable user interface element 710a that includes selectable user interface element 710f. In some embodiments, in response to detecting selection of selectable user interface element 710a or 71Of, the computer system expands selectable user interface element 710a to display selectable navigation user interface objects 710b, 710c, 710d, and 710e displayed in FIG. 7A.

In some embodiments, when the computer system 101 increases the level of immersion, the navigation user interface 704b includes more selectable travel user interface objects. For example, in FIG. 7B, the computer system 101 displays the navigation user interface 704b including additional travel user interface objects 708e and 708f, that were not previously included when the computer system 101 displayed the navigation user interface 704a as partially immersive shown in FIG. 7A.

In some embodiments, the computer system displays the travel user interface objects at respective locations in the navigation user interface 704b corresponding to respective views and/or respective physical locations associated with the respective travel user interface objects. For example, in FIG. 7B, the navigation user interface 704b includes travel user interface object 708f that, when selected, causes the computer system 101 to update the display of the navigation user interface 704b to correspond to a respective viewpoint and/or physical location associated with travel user interface object 708f (e.g., a viewpoint from atop the building). In another example, the navigation user interface 704b includes travel user interface object 708e that, when selected, causes the computer system 101 to update the display of the navigation user interface 704b to correspond to a respective viewpoint and/or physical location associated with travel user interface object 708e (e.g., a viewpoint from golden gate bridge that is in a location different from the physical location displayed via navigation user interface 704b in FIG. 7B). In another example, the computer system detects user input 718b (e.g., an input similar to or corresponding to the input described above) directed to travel user interface object 708b. In response to receiving user input 718b directed to travel user interface object 708b, the computer system 101 changes the display of the navigation user interface 704b. For example, while the computer system 101 displays navigation user interface 704b as corresponding to a first view of a first physical location as shown in FIG. 7B, the computer system 101 receives the user input 718b directed to travel user interface object 708b. In response to receiving the user input 718b directed to travel user interface object 708b, the computer system 101 displays navigation user interface 704b corresponding to a second view of a second physical location, different from the first view of the first physical location as shown in FIG. 7C. For example, the second view of the second physical location includes a street level view image from a location that is north west of the building while the first view of the first physical location includes a street level view image from a location that is south east of the building.

In FIG. 7C, the computer system 101 displays navigation user interface 704b corresponding to the second view of the second physical location in response to receiving the input illustrated in FIG. 7B. For example, the second view of the second physical location includes travel user interface objects 720a, 720b, 720c, 720f, 720e, and 720f that are different from the travel user interface objects displayed by navigation user interface 704b in FIG. 7B that corresponds to the second view of the first physical location. In some embodiments, the computer system 101 displays different types of travel user interface objects. For example, navigation user interface 704b includes travel user interface object 720e which is a type of travel user interface object different from travel user interface object 720b. In some embodiments, when selected, travel user interface object 720e causes the computer system 101 to perform an operation that is different from the operation associated with travel user interface object 720b. For example, in response to detecting an input selecting travel user interface object 720e, the computer system 101 displays images of the respective physical location captured by another user, different from the user of the computer system 101. In another example, in response to detecting an input selecting travel user interface object 720b, the computer system 101 displays satellite images of the respective physical location.

In some embodiments, the computer system 101 displays navigation user interface 704b including a representation 722a of a business located within the respective physical location. For example, in FIG. 7C, representation 722a includes a description of the business and selectable user interface objects 722b and 722c that, when selected, cause the computer system 101 to communicate with the business and launch a webpage of the business, respectively. In some embodiments, the navigation user interface 704b further includes a travel user interface object 720a that, when selected, causes the computer system 101 to display the navigation user interface 704b from the previous view and/or location. For example, the computer system detects user input 718c (e.g., an input similar to or corresponding to the input described above) directed to travel user interface object 720a. In response to receiving user input 718c directed to travel user interface object 720a, the computer system 101 changes the display of the navigation user interface 704b corresponding to the second view of the second physical location as shown in FIG. 7C to the previous respective view of the respective physical location as shown in FIG. 7D. In FIG. 7D, the navigation user interface 704b includes user interface object and/or elements similar to or corresponding to the navigation user interface 704b including user interface objects and/or elements displayed in FIG. 7B.

In some embodiments, the computer system 101 displays the navigation user interface 704b corresponding to a respective view of the respective physical location including annotations such as text, images, and/or references to other information (e.g., links). In some embodiments, the computer system 101 displays said annotations proximate to their corresponding physical locations within the respective view of the respective physical location. In some embodiments, annotations are created by the user, via the computer system 101, to describe or provide useful information about the physical location. For example, in FIG. 7D, the computer system 101 detects voice input 724 from the user corresponding to a request to add an annotation to the respective view of the respective physical location. In response to receiving the voice input 724, the computer system 101 generates and displays a representation 726 of the annotation as shown in FIG. 7E. In some embodiments, the computer system 101 displays a notification to the user of the annotation when computer system 101 is physically located at a respective location corresponding to the annotation as will be described below with reference to FIG. 7P.

As previously described herein, the navigation user interface 704b includes a collapsed view of selectable user interface element 710a that includes selectable user interface element 710f in FIG. 7E. In some embodiments, the computer system 101 detects user input 718e (e.g., an input similar to or corresponding to the input described above) directed to selectable user interface element 710f. In response to receiving user input 718e directed to selectable user interface element 710f in FIG. 7E, the computer system 101 changes the display of the navigation user interface 704b to include an expanded selectable user interface element 710a as shown in FIG. 7F. In FIG. 7F, expanded selectable user interface element 710a includes selectable navigation user interface objects 710b, 710c, 710d, and 710e.

In some embodiments, in response to detecting an input selecting a respective one of navigation user interface objects 710b, 710c, 710d, the computer system 101 displays a respective navigation user interface element associated with the respective physical location displayed by navigation user interface 704b. For example, in response to receiving an input selecting navigation user interface object 710b, the computer system 101 displays navigation user interface element 754 corresponding to a globe described below with reference to FIG. 7N. Returning to FIG. 7F, selectable user interface element 710a includes selectable user interface element 710c that, when selected, causes the computer system 101 to display navigation user interface element 714 as described in more detail in the FIGS. 7G-7M. In some embodiments, selectable user interface element 710a includes navigation user interface object 710d that, when selected, causes the computer system 101 to display navigation user interface 704b corresponding to a respective view of a respective physical location as described herein, such as the respective view included in navigation user interface 704b in FIG. 7F. In some embodiments, selectable user interface element 710a includes navigation user interface object 710e that, when selected, causes the computer system 101 to display video content associated with the respective physical location, such as an aerial tour video of the respective physical location.

In FIG. 7F, the computer system 101 detects user input 718f (e.g., an input similar to or corresponding to the input described above) directed to selectable user interface element 710c. In response to receiving user input 718f directed to selectable user interface element 710c, the computer system 101 displays navigation user interface element 714 and changes the display of the navigation user interface 704b from a fully immersive view as shown in FIG. 7F to a partially immersive view as shown in FIG. 7G. In some embodiments, in response to receiving user input 718f directed to selectable user interface element 710c and voice input from the user corresponding to a request to decrease the level of immersion (e.g., change the level of immersion to be partially immersive), the computer system 101 displays navigation user interface element 714 and changes the display of the navigation user interface 704b from a fully immersive view as shown in FIG. 7F to a partially immersive view as shown in FIG. 7G. In some embodiments, in response to receiving user input 718f directed to selectable user interface element 710c, the computer system 101 overrides the current level of immersion (e.g., changes the display of the navigation user interface 704b from a fully immersive view as shown in FIG. 7F to a partially immersive view as shown in FIG. 7G) and displays navigation user interface element 714 as shown in FIG. 7G. The navigation user interface 704a in FIG. 7G includes similar user interface objects and/or elements displayed in FIG. 7A including the representation 726 of the annotation. The navigation user interface element 714 has one or more characteristics and/or includes similar user interface objects and/or elements displayed in FIG. 7A.

In some embodiments, in response to receiving user input 718f directed to selectable user interface element 710c, the computer system 101 displays navigation user interface element 714 shown in FIG. 7G and maintains a high level of immersion. For example, displaying the three-dimensional environment with a high level of immersion includes displaying navigation user interface 704b and navigation user interface element 714 with greater visual prominence (e.g., size, brightness, clarity, opacity, etc.) than the visual prominence of representations of real objects in the three-dimensional environment. In some embodiments, the passthrough video (e.g., the representation of the physical environment of the computer system 101) is hidden. In another example, displaying the three-dimensional environment with a high level of immersion includes displaying the navigation user interface 704b with a fully immersive view as shown in FIG. 7F and the navigation user interface element 714 overlaid on the fully immersive view. In FIG. 7G, the computer system displays navigation user interface 704a that corresponds to a first view of a first physical location, different from the second view of the first physical location as shown in FIG. 7E. FIG. 7G also includes navigation user interface element 714. In some embodiments, navigation user interface element 714 has one or more characteristics and/or includes similar user interface objects and/or elements displayed in FIG. 7A.

In some embodiments, the computer system 101 detects a posture of the user of the computer system and determines that the posture of the user indicates engagement with the navigation user interface element 714. For example, in response to detecting the user's head leaning in towards the navigation user interface element 714, the computer system 101 displays the navigation user interface element 714 with a level of zoom in accordance with the posture of the user. FIG. 7G displays legend 732 depicting a first posture of the user 734 of the computer system interacting with the navigation user interface element 714 depicted as positioned atop selectable user interface control element 716. In some embodiments, the computer system 101 detects the gaze 728 of the user of the computer system 101 directed to navigation user interface element 714. In some embodiments, in response to the computer system detecting the gaze 728 of the user of the computer system 101 directed to navigation user interface element 714, the computer system 101 outputs spatial audio 730 that corresponds to environmental noise at the respective physical location corresponding to the location of the user's gaze 728. In some embodiments, the computer system displays navigation user interface element 714 with a level of zoom and/or perspective corresponding to the posture of the user 734 as depicted by legend. 732.

As shown in FIG. 7H, in response to the computer system detecting the gaze 728 of the user of the computer system 101 directed to navigation user interface element 714, the computer system 101 zooms in on the display of the navigation user interface element 714. In some embodiments, the computer system 101 ceases display of the respective content corresponding to the respective view of the respective physical location and displays representation 736 of content related to the respective physical location, such as text, images, and/or video related to the respective physical location as shown in FIG. 7H in response to detecting the gaze of the user. In some embodiments, the computer system 101 changes the spatial audio 730 that is output to correspond to the zoomed in view of the respective physical location. For example, in FIG. 7H, the computer system 101 displays the navigation user interface element 714 representing a smaller area of the respective physical location with more detail than the area of the respective location with a level of detail that was displayed in FIG. 7G. From FIG. 7G to FIG. 7H, the computer system 101 increases the volume of the spatial audio 730 in response to the computer system 101 zooming in on the navigation user interface element.

In some embodiments, the computer system 101 continues detecting zooming input from the user of the computer system 101. For example, in FIG. 7H, legend 732 depicts user 734 with changed posture corresponding to leaning further over and looking down at navigation user interface element 714 with gaze maintained at the navigation user interface element 714 and, in particular, a representation of a building. In some embodiments, in response to detecting the changed posture of the user with gaze maintained at the particular building presented by the navigation user interface element 714, the computer system 101 displays representations of the building and areas immediately surrounding the building with higher definition than representations of areas beyond a predetermined distance from the building as shown in FIG. 7I.

In addition to zooming in and/or out of the navigation user interface element 714, the computer system 101 changes the position and/or orientation of the navigation user interface element in response to receiving inputs directed to the selectable user interface control element 716. For example, in FIG. 7I, the computer system 101 detects inputs 738 (e.g., an input similar to or corresponding to the input described above) directed to the selectable user interface control element 716 corresponding to a request to zoom out and rotate (e.g., 740i) of the navigation user interface element 714. In response to the inputs 738, the computer system 101 displays the navigation user interface element 714 representing a rotated and zoomed out view of the respective physical location. In some embodiments, the computer system 101 changes the spatial audio that is output accordingly, as shown in FIG. 7J. For example, in FIG. 7J, the computer system outputs spatial audio 742 that corresponds to environmental noise at the respective physical location and lowers the volume of spatial audio 730 in accordance with the request to zoom out and rotate the navigation user interface element 714. In some embodiments, the computer system 101 changes the representation 736 to include content related to the zoomed out view of the respective physical location as shown in FIG. 7J.

In some embodiments, as shown in FIG. 7J, while displaying the rotated and zoomed view of the respective location, the computer system 101 detects further inputs 738 (e.g., an input similar to or corresponding to the input described above) directed to the selectable user interface control element 716 corresponding to a request to zoom out more and rotate (e.g., 740j) the navigation user interface element 714. In response to the inputs 738, the computer system 101 displays the navigation user interface element 714 representing a more zoomed out and rotated view of the respective physical location in FIG. 7K. In FIG. 7K, the computer system lowers the volume of spatial audio 730 even more in accordance with the zoom out request and increases spatial audio 742 corresponding to the environmental noise at the respective physical location now represented by navigation user interface element 714. In some embodiments and as shown in FIG. 7K, the computer system determines that user input 738 is directed to a first portion of the selectable user interface control element 716k (e.g., outer portion) different from portion of the selectable user interface control element 716j (e.g., inner portion) shown by user input 738 in FIG. 7J. In some embodiments, the computer system rotates the navigation user interface element 714 with a faster speed when the user input 738 is directed to a first portion of the selectable user interface control element 716j than when the user input 738 is directed to a portion different from the first portion of the selectable user interface control element 716k as shown in FIG. 7J. In some embodiments, the computer system scales both the navigation user interface element 714 and the selectable user interface control element 716 in response to receiving inputs directed to selectable user interface control element 716. In some embodiments, the computer system scales the navigation user interface element 714 but not the selectable user interface control element 716 in response to receiving inputs directed to the navigation user interface element 714.

In some embodiments, while the computer system 101 displays navigation user interface element 714 representing a more zoomed out and rotated view of the respective physical location, the computer system 101 detects user input 738 (e.g., an input similar to or corresponding to the input described above) directed to the selectable user interface control element 716 corresponding to a request to zoom in and rotate (e.g., 740k) on the navigation user interface element 714 as shown in FIG. 7K. In response, the computer system 101 displays the navigation user interface element 714 representing a zoomed in and rotated view of the respective physical location as shown in FIG. 7L. In some embodiments, in response to the request to zoom in and rotate, the computer system 101 outputs spatial audio 730 with an even lower volume in accordance with rotating the navigation user interface element 714 because the portion of the navigation user interface element 714 associated with spatial audio 730 is no longer (or only partially) in view. In some embodiments, the computer system 101 increases spatial audio 742 as shown in FIG. 7L in accordance with zooming in on a portion of the navigation user interface element 714 associated with spatial audio 742. In some embodiments, the computer system 101 changes the representation 736 to include content related to the zoomed in view of the respective physical location as shown in FIG. 7L.

In some embodiments, while the computer system 101 displays navigation user interface element 714 representing a zoomed in and rotated view of the respective physical location, the computer system 101 detects user input 738 (e.g., an input similar to or corresponding to the input described above) directed to the selectable user interface control element 716 corresponding to a request to zoom out (e.g., 740) of the navigation user interface element 714 as shown in FIG. 7L. In response to receiving the input shown in FIG. 7L, the computer system 101 displays the navigation user interface element 714 representing a zoomed out view of the respective physical location and outputs spatial audio 730 with a similar lower volume and slightly decreases the spatial audio 742 to correspond with the zoomed out view of the respective physical location as shown in FIG. 7M. In some embodiments, the computer system 101 changes the representation 736 to include content related to the zoomed out view of the respective physical location as shown in FIG. 7M.

In FIG. 7M, the computer system 101 detects user input 738 (e.g., an input similar to or corresponding to the input described above) directed to the selectable user interface control element 716 corresponding to a request to zoom out (e.g., 740) a greater amount than the request to zoom out in FIG. 7L. In response to receiving the input in FIG. 7M, the computer system 101 displays navigation user interface element 754 corresponding to a globe in FIG. 7N that is positioned and/or oriented such that the respective physical location is in the center of the field of view of the user. In FIG. 7N, navigation user interface element 754 includes land masses (e.g., 758), bodies of water, and/or two-dimensional representations of points of interests (e.g., 746, 748, 750, and 752) positioned in locations on the navigation user interface element 754 corresponding to their respective physical locations. In some embodiments, in response to receiving an input selecting a the representation of a point of interest (e.g., 746, 748, 750, and/or 752), the computer system 101 displays information related to the respective point of interest similar to representation 722a in FIG. 7C. In some embodiments, navigation user interface element 754 further includes a representation 744 of weather at the respective physical location.

In some embodiments, similarly to navigation user interface element 714, navigation user interface element 754 is interactive. For example, in FIG. 7N, the computer system detects user input 718 (e.g., an input similar to or corresponding to the input described above) directed to the navigation user interface element 754 corresponding to a request to rotate navigation user interface element 754. In response to the detecting the user input 718, the computer system 101 rotates navigation user interface element 754 to display a different portion of the navigation user interface element 754 as shown in FIG. 7O that was not previously displayed by navigation user interface element 754 in FIG. 7N. For example, in FIG. 7O, the navigation user interface element 754 includes land mass 760 that includes an indication of topography. In FIG. 7O, the computer system also displays representations of points of interests (e.g., 746, 748, 750, and 752) positioned in locations on the navigation user interface element 754 corresponding to their respective physical locations. Additional or alternative representations of additional or alternative map virtual objects, user interface elements, information and/or features are also contemplated and described with reference to method 800.

In some embodiments, and as mentioned above, the computer system 101 displays a notification to the user of the annotation when computer system 101 is physically located at the respective physical location corresponding to the annotation. In some embodiments, another computer system associated with the same user account as computer system 101 displays the annotation. For example, in FIG. 7P, a second computer system 101 presents an immersive augmented reality 762 along with a representation 766 of the annotation as described above. In some embodiments, in response to detecting an input selecting representation 766, the computer system 101p displays information related to the annotation

In some embodiments, the computer system 101 shares the navigation user interface 704a with a second computer system associated with a different user account than computer system 101. For example, FIG. 7Q illustrates two different computer systems, computer system 101a associated with user Mary and computer system 101b associated with user Bob, in a shared communication session. Legend 768 depicts user Mary (e.g., representation 770) and user Bob (representation 772) and their respective computer systems in different physical environments, for example. In FIG. 7Q, computer system 101a associated with the user Mary displays a representation of a navigation user interface with a fully immersive view including selectable travel user interface objects 774a, 774b, and 774c. In some embodiments, in response to receiving an input selecting selectable travel user interface object 774b, computer system 101a displays the view of the navigation user interface corresponding to the viewpoint of the user Bob (e.g., display the navigation user interface associated with the user Bob from the viewpoint of the user Bob). In FIG. 7Q, computer system 101b associated with the user Bob displays a representation of a navigation user interface with a fully immersive view including selectable travel user interface objects 776a, 776b, and 776c. In some embodiments, in response to receiving an input selecting selectable travel user interface object 776a, computer system 101b displays the view of the navigation user interface displayed by the computer system 101a associated with the user Mary from the viewpoint of the user Mary.

FIG. 8 is a flowchart illustrating an exemplary method of displaying a navigation user interface with a respective level of immersion corresponding to a respective view of a respective physical location in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system (e.g., 101) in communication with a display generation component (e.g., 120) and one or more input devices (e.g., 314). For example, the computer system is or includes a mobile device (e.g., a tablet, a smartphone, a media player, or a wearable device), or a computer. In some embodiments, the display generation component is a display integrated with the computer system (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, or a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the computer system displays (802a), via the display generation component, a navigation user interface within a three-dimensional environment, such as navigation user interface 704a within three-dimensional environment 702 in FIG. 7A. For example, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, a physical environment surrounding the display generation component is visible through a transparent portion of the display generation component (e.g., true or real passthrough). In some embodiments, a representation of the physical environment is displayed in the three-dimensional environment via the display generation component (e.g., virtual or video passthrough). In some embodiments, the navigation user interface includes one or more first travel user interface elements displayed at a first level of immersion corresponding to a first view of a first physical location, such as selectable travel user interface objects 708a, 708b, 708c, and 708d in FIG. 7A.

In some embodiments, the computer system displays the navigation user interface in the three-dimensional environment that is in the field of view of a user of the computer system from a viewpoint of the user of the three-dimensional environment. In some embodiments, the navigation user interface is a user interface of a map application. In some embodiments, the navigation user interface is a user interface of an application other than the map application, such as a travel guide application. In some embodiments, the navigation user interface includes respective content corresponding to the first view of the first physical location, such as one or more images or video taken from and/or of the first physical location (e.g., one or more street level view image(s) and/or video(s) from the first physical location). In some embodiments, the respective content is (e.g., live) video recorded at the first physical location. The navigation user interface including the respective content corresponding to the first view of the first physical location is optionally presented from a first-person perspective from the viewpoint of a user associated with the computer system at a respective location in the three-dimensional environment (e.g., corresponding to the location of the computer system). In some embodiments, the computer system is configured to increase or decrease a level of immersion of the navigation user interface (e.g., increases or decreases a quantity of virtual elements including travel user interface elements in the navigation user interface and/or increases or decreases a portion of which the navigation user interface occupies the three-dimensional environment). In some embodiments, a level of immersion includes an associated degree to which the navigation user interface and/or virtual content displayed by the computer system obscures background content (e.g., the three-dimensional environment including the physical environment) around/behind the virtual content, optionally including a number of items of background content displayed and the visual characteristics (e.g., colors, contrast, and/or opacity) with which the background content is displayed, and/or the angular range of the content displayed via the display generation component (e.g., 60 degrees of content displayed at low immersion, 120 degrees of content displayed at medium immersion, and/or 180 degrees of content displayed at high immersion), and/or the proportion of the field of view displayed via the display generation consumed by the virtual content (e.g., 33% of the field of view consumed by the virtual content at low immersion, 66% of the field of view consumed by the virtual environment at medium immersion, and/or 100% of the field of view consumed by the virtual content at high immersion).

In some embodiments, at a first (e.g., low) level of immersion, the background, virtual and/or real objects are displayed in an obscured manner (e.g., dimmed, blurred, and/or removed from display). For example, virtual content with a low level of immersion is optionally displayed concurrently with the background content, which is optionally displayed with full brightness, color, and/or translucency. In some embodiments, at a second (e.g., high) level of immersion, the background, virtual and/or real objects are displayed in an obscured manner. For example, respective virtual content with a high level of immersion is displayed without concurrently displaying the background content (e.g., in a full screen or fully immersive mode). As another example, virtual content displayed with a medium level of immersion is optionally displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, the navigation user interface with the first level of immersion includes the one or more first travel user interface elements that, when selected, cause the computer system to change the display of the navigation user interface from the first view of the first physical location to a view of the selected first travel user interface element, such as a second view of a second physical location as described herein.

In some embodiments, while displaying, via the display generation component, the navigation user interface including the one or more first travel user interface elements, the computer system detects (802b), via the one or more input devices, a first input corresponding to a request to change a level of immersion, such as hand 718a manipulating physical buttons 778a and/or 778b in FIG. 7A. For example, the computer system optionally detects the first user input (e.g., a gaze of the user, a contact on a touch-sensitive surface, actuation of a physical input device, a predefined gesture (e.g., pinch gesture or air tap gesture) and/or a voice input from the user) corresponding to the request to change the level of immersion of the navigation user interface.

In response to detecting the first input (802c), the computer system changes (802d) the display of the navigation user interface with the first level of immersion corresponding to the first view of the first physical location, such as navigation user interface 704a in FIG. 7A to a second level of immersion corresponding to the first view of the first physical location, such as navigation user interface 704b in FIG. 7B, wherein the second level of immersion includes one or more second travel user interface elements, different from the one or more first travel user interface elements, such as selectable travel user interface objects 708a, 708b, 708c, 708d, 708e, and 708f in FIG. 7B that are selectable to change the display of the navigation user interface from the first view of the first physical location to a second view of a second physical location, such as the second view of the second physical location in navigation user interface 704b in FIG. 7C. In some embodiments, the navigation user interface with the second level of immersion including the one or more second travel user interface elements are greater (e.g., in quantity) than the one or more first travel user interface elements associated with the navigation user interface with the first level of immersion. In some embodiments, the navigation user interface with the second level of immersion including the one or more second travel user interface elements are less (e.g., in quantity) than the one or more first travel user interface elements associated with the navigation user interface with the first level of immersion. In some embodiments, the one or more second travel user interface elements are a second type of travel user interface elements, different from the first type of travel user interface elements associated with the one or more first travel user interface elements. For example, the first type of travel user interface elements optionally include views from a street level while the second type of travel user interface elements include views from the street level and other levels, such as an overhead view. In another example, the first type of travel user interface elements optionally include views from physical locations within a predetermined distance (e.g., 0.02, 0.04, 0.06, 0.08, 0.2, 0.4, 0.6, 0.8, 1, 1.5, 2, 3, 4, 5, 6, 7, 8, 9, or 10 kilometers) from the first physical location while the second type of travel user interface elements optionally include views from physical locations beyond the first predetermined distance from the first physical location.

In some embodiments, changing the display of the navigation user interface with the second level of immersion to correspond to the second view of the second physical location associated with the second travel user interface element includes the computer system displaying an image taken from the second physical location, different from the first physical location. In some embodiments, changing the display of the navigation user interface with the second level of immersion to correspond to the second view of the second physical location associated with the second travel user interface element includes the computer system displaying (e.g., live) video recorded at the second physical location. In some embodiments, changing the display of the navigation user interface with the second level of immersion to correspond to the second view of the second physical location associated with the second travel user interface element includes updating the viewpoint of the user to be located at the location of the second travel user interface element within the three-dimensional environment. In some embodiments, as described below, the first view is different from the second view regardless of being associated with a same physical location. In some embodiments, the one or more first travel user interface elements are selectable to change the display of the navigation user interface with the second level of immersion corresponding to the first view of the first physical location to correspond to a third view of a third physical location associated with the respective one or more first travel user interface elements. In some embodiments, changing the display of the navigation user interface with the second level of immersion to correspond to the third view of the third physical location associated with the first travel user interface element includes the computer system displaying an image taken from the third physical location, different from the second physical location. In some embodiments, changing the display of the navigation user interface with the second level of immersion to correspond to the third view of the third physical location associated with the first travel user interface element includes the computer system displaying (e.g., live) video recorded at the third physical location. In some embodiments, changing the display of the navigation user interface with the second level of immersion to correspond to the third view of the third physical location associated with the first travel user interface element includes updating the viewpoint of the user to be located at the location of the first travel user interface element within the three-dimensional environment. In some embodiments, the computer system displays the navigation user interface with the second level of immersion including the one or more first travel user interface elements and the one or more second travel user interface elements are in respective locations of the navigation user interface (e.g., at different depths and/or heights that are not in conflict). Changing a quantity of travel user interface elements displayed based on a level of immersion wherein the respective travel user interface element, when selected causes the computer system to change the display of the navigation user interface with a respective level of immersion corresponding to the first view of the first physical location to correspond to a second view of a second physical location associated with the respective travel user interface element provides quick display of the respective location without requiring the user to traverse a map and reduces clutter caused by displaying too many travel user interface elements, thereby reducing the number of inputs and providing more efficient interactions between the user and the computer system.

In some embodiments, the first view of the first physical location includes a first perspective from a simulated camera, such as the first view of the first physical location in navigation user interface 704b in FIG. 7B. In some embodiments, the first perspective from the simulated camera optionally includes a first simulated camera angle relative to a normal (perpendicular) to the ground (e.g., the simulated camera is pointed at an angle towards a scene (or environment) of the first physical location. In some embodiments, the first perspective from the simulated camera includes a first angle normal to the ground or away from normal, such as 60, 65, 70, 75, 80, 85, 90, 100, 110, 120, 130, 140, 150, or 160 degrees and/or a first distance from the ground, such as 50, 60, 70, 80, 90, 100, 150, 200, 250, 300, 400, or 500 centimeters from the ground. For example, the first perspective from the simulated camera includes a street level perspective of the first physical location.

In some embodiments, the second view of the second physical location is from a second perspective from the simulated camera, different from the first perspective from the simulated camera, such as the second view of the second physical location in navigation user interface 704b in FIG. 7C. In some embodiments, the second perspective from the simulated camera includes a second angle normal from the ground or away from normal that is the same, less than, or greater than the first angle associated with the first perspective, such as 2, 5, 10, 20, 30, 40, 50, 60, 70, 80, or 90 degrees. In some embodiments, the second perspective from the simulated camera includes a second distance from the ground that is the same, less than, or greater than the first distance associated with the first perspective, such as 5, 10, 50, 100, 200, 300, 400, 500, 600, 700, 800, 900, or 1000 meters from the ground. For example, the second perspective from the simulated camera is optionally above the street level (e.g., on a roof, balcony, or other overhead view) or below the street level (e.g., in a public transit tunnel, boat, or other below ground view). In some embodiments, the second perspective includes different map information and/or satellite imagery as described below with respect to different zoom levels. Providing a respective view of a respective physical location from different perspectives via travel user interface elements enables a user to easily view and experience a first physical location from a variety of perspectives, thereby reducing the need for subsequent inputs from a user to zoom, rotate, and/or pan the respective view of the respective location which reduces power usage and improves battery life of the computer system by enabling the user to use the computer system more quickly and efficiently.

In some embodiments, while displaying the navigation user interface corresponding to the first view of the first physical location, the computer system displays, via the display generation component, a first navigation user interface element within the three-dimensional environment, wherein the first navigation user interface element represents a third view of the first physical location, such as navigation user interface element 714 in FIG. 7A. For example, the first navigation user interface element optionally includes a three-dimensional topographical map of a physical location associated with the first location experience. In some embodiments, the three-dimensional topographical map includes satellite image data of different resolutions as described in more detail below with reference to zoom levels. For example, the first navigation user interface element includes a three-dimensional topographical map of a city including three-dimensional representations of buildings, streets, and other landmarks with a flag, pin, or other visual indication displayed at the first location that corresponds to an address, landmark, or coordinates in the city. In some embodiments, the computer system displays the first navigation user interface element representing a third view of the first physical location as oriented along a horizontal surface in the three-dimensional environment or floating along a horizontal plane and the respective content corresponding to the first view of the first physical location is oriented vertically. In some embodiments, the first navigation user interface element is between the viewpoint of the user and the respective content in the three-dimensional environment. In some embodiments, the computer system will change the display of the first navigation user interface element (e.g., rotate, re-size, and/or tilt) and/or render a respective portion of the first navigation user interface element at a zoom level to focus on an area and/or location of the map that is associated with the first physical location. For example, when the first navigation user interface element represents the third view of the first physical location, the computer system optionally displays the first navigation user interface element with a first rotation, first size, first zoom level, and/or first tilt such that the first navigation user interface element is centered on an area and/or portion associated with the first physical location (e.g., without changing the viewpoint of the user of the computer system). In some embodiments, the first navigation user interface element representing the third view of the first physical location includes a same, larger, or smaller area of the first physical location than an area of the respective physical location associated with the display of the respective content with the respective level of immersion. In some embodiments, the respective content is concurrently displayed with the first navigation user interface element. In some embodiments, and as will be described below, the computer system does not display the respective content concurrently with the first navigation user interface element. In some embodiments, the first navigation user interface element is a two-dimensional map of the first physical location.

In some embodiments, the first navigation user interface element includes an indication (e.g., a visual indication) of a location of a viewpoint displayed at a respective location within the first navigation user interface element. For example, the computer system optionally displays within the first navigation user interface element a visual indication (e.g., binoculars icon or other graphical representation) corresponding to the location of the first view of the first physical location (e.g., the location at which the first view of the first physical location was captured by a camera or simulated camera).

In some embodiments, the first navigation user interface element includes an indication of a field of view displayed at a respective orientation relative to the first navigation user interface element. For example, the computer system optionally displays within the first navigation user interface element a visual indication of the field of view corresponding to the orientation first view of the first physical location (e.g., relative to a fixed coordinate system of the first physical location). In some embodiments, the indication of the field of view is displayed proximate to or in association with (e.g., proximate to or incorporated with) the indication of the location of the view corresponding to the location of the first view of the first physical location described herein. In some embodiments, the indication of the field of view indicates the boundaries of the first physical location that are displayed within the respective content. In some embodiments, the computer system updates the indication of the location of the view and the indication of the field of view in accordance with a changed location and/or orientation of the respective content. It is understood that although the embodiments described herein are directed to the respective content corresponding to the first view of the first physical location, such indications and associated functions and/or characteristics, optionally apply with respect to other views and/or physical locations including the second view of the second physical location. Providing an indication of the location of a viewpoint and/or the field of view according to the displayed respective content provides an efficient way of indicating the portion of the first physical location represented by the respective content, which reduces power usage and improves battery life of the computer system by enabling the user to use the computer system more quickly and efficiently.

In some embodiments, the navigation user interface with the first level of immersion occupies a first portion of the three-dimensional environment, such as navigation user interface 704a occupying a portion of the three-dimensional environment 702 in FIG. 7A. In some embodiments, the navigation user interface with the second level of immersion occupies a second portion of the three-dimensional environment, greater than the first portion of the three-dimensional environment, such as navigation user interface 704b occupying a second portion of the three-dimensional environment 702 in FIG. 7B. In some embodiments, the computer system increases or decreases the size at which the navigation user interface is displayed in the three-dimensional environment by the display generation component. For example, a display area of the navigation user interface occupied by the respective content corresponding to the first view of the first physical location is optionally increased in response to detecting the first input (e.g., capturing a user input and/or receiving a user input) corresponding to a request to change a level of immersion. As described above with respect to levels of immersion, when displaying the navigation user interface with the second level of immersion, the computer system optionally replaces, obscures, or blocks the view of physical objects or surfaces (e.g., front wall, front wall and ceiling, front wall and floor, front wall and side walls, and/or a combination of any of the forementioned) with the respective content including newly displayed virtual elements (e.g., travel user interface elements) or newly displayed portions of the respective content that were not previously displayed when displaying the navigation user interface with the first level of immersion. As another example, when displaying the navigation user interface with the second level of immersion, the computer system optionally replaces, obscures, or blocks the view of less (or a subset of) physical objects or a portion of surfaces (e.g., half of the front wall, ceiling, or floor) with the respective content including a subset of virtual elements (e.g., travel user interface elements) or less portions of the respective content than were previously displayed when displaying the navigation user interface with the second level of immersion. In some embodiments, displaying and/or changing the navigation user interface with a respective level of immersion is performed by the computer system without user input to change a level of immersion of the navigation user interface. Displaying the navigation user interface with a varying levels of immersion occupying larger or smaller portions of the three-dimensional environment provides an efficient way of presenting a smaller or greater view of the first physical location, thereby reducing the need for subsequent inputs from a user to manipulate the view of the first physical location which reduces power usage and improves battery life of the computer system by enabling the user to use the computer system more quickly and efficiently.

In some embodiments, displaying, via the display generation component, the navigation user interface including a respective content with a respective level of immersion includes displaying the navigation user interface in a manner to simulate the navigation user interface being oriented along a physical object within a physical environment surrounding the computer system, such as a wall in the physical environment in FIG. 7A. For example, the computer system optionally displays the navigation user interface overlaid on a physical wall or any surface as described above, or no surface at all, such as overlaid upon a virtual object. In some embodiments, the computer system displays the navigation user interface laid flat or curved spherically around the user of the computer system. In some embodiments, the navigation user interface is displayed as curved or as any shape to map to any physical surface or virtual object. In some embodiments, the navigation user interface includes a two-dimensional map aligned with a representation of a physical wall. In some embodiments, the navigation user interface includes a three-dimensional map laid on a representation of a physical table. In some embodiments, the physical wall, physical table, and other physical objects described herein surround the display generation component and is visible through a transparent portion of the display generation component (e.g., true or real passthrough). For example, a representation of the physical environment including the representation of the physical wall and the representation of the physical table is displayed in the three-dimensional environment via the display generation component (e.g., virtual or video passthrough). Displaying the navigation user interface in a manner to simulate the navigation user interface being oriented along a physical object within the physical environment surrounding the computer system provides an efficient way of presenting a view of the first physical location as if part of the physical environment, thereby taking advantage of the physical environment of the computer system reducing the need for subsequent inputs from a user to manipulate the view of the first physical location which reduces power usage and improves battery life of the computer system by enabling the user to use the computer system more quickly and efficiently.

In some embodiments, while displaying the navigation user interface with the second level of immersion including the one or more second travel user interface elements, the computer system detects, via the one or more input devices, a second input directed to a respective travel user interface element, such as user input 718c directed to travel user interface object 720a in FIG. 7C. For example, the computer system optionally detects the second input (e.g., a gaze of the user, a contact on a touch-sensitive surface, actuation of a physical input device, a predefined gesture (e.g., pinch gesture or air tap gesture) and/or a voice input from the user) directed to a respective travel user interface element. In some embodiments, the respective travel user interface element corresponds to a request to change a view of the respective physical location and/or the respective physical location.

In some embodiments, in response to detecting the second input, and in accordance with a determination that the respective travel user interface element is a first travel user interface element of the one or more second travel user interface elements, the computer system changes the display of the navigation user interface with the second level of immersion corresponding to the first view of the first physical location to the second level of immersion corresponding to a second view of a second physical location, such as changing from navigation user interface 704b in FIG. 7B to navigation user interface 704b in FIG. 7C. In some embodiments, changing the display of the navigation user interface with the second level of immersion to correspond to the second view of the second physical location includes one or more characteristics of the display of the navigation user interface with the second level of immersion corresponding to the second view of the second physical location described above.

In some embodiments, in response to detecting the second input, and in accordance with a determination that the respective travel user interface element is a second travel user interface element of the one or more second travel user interface elements, different from the first travel user interface element, the computer system changes the display of the navigation user interface with the second level of immersion corresponding to the first view of the first physical location to the second level of immersion corresponding to a third view of a third physical location, different from the second view of the second physical location. In some embodiments, changing the display of the navigation user interface with the second level of immersion to correspond to the third view of the third physical location includes one or more characteristics of the display of the navigation user interface with the second level of immersion corresponding to the third view of the third physical location described above. In some embodiments, the computer system automatically (or in response to user input) moves or relocates the navigation user interface including the display of the respective content from a first location within the physical environment surrounding the computer system to a second location within the physical environment surrounding the computer system (e.g., from being oriented along a first physical object within the physical environment surrounding the computer system to being oriented along a second physical object within the physical environment surrounding the computer system). In some embodiments, the second location is automatically selected by the computer system or is selected by the user of the computer system. In some embodiments, the size of the display of the respective content optionally does not change (e.g., remains the same). In some embodiments, the second location is optionally further away than the first location (relative to the viewpoint of the user), such that the display of the respective content appears smaller relative to the user's perspective than when displaying the display of the respective content at the first location. In another example, the second location is optionally closer than the first location (relative to the viewpoint of the user), such that the display of the respective content appears larger relative to the user's perspective than when displaying the display of the respective content at the first location. In some embodiments, the computer system automatically (or in response to user input) resizes and/or changes the size of the display of the respective content. Changing a display of the navigation user interface corresponding to the first view of the first physical location to correspond to a respective view of a respective physical location associated with a respective travel user interface element provides quick display of the respective physical location without requiring the user to traverse a map, thereby reducing the number of inputs and providing more efficient interactions between the user and the computer system.

In some embodiments, wherein displaying the navigation user interface with the second level of immersion corresponding to the second view of a second physical location includes displaying a travel option that, when selected, causes the computer system to display a previous view of a respective physical location, such as travel user interface object 720a in FIG. 7C. In some embodiments, the travel option is displayed as part of the navigation user interface at a location that does not disrupt the respective level of immersion of the navigation user interface. In some embodiments, the computer system displays the travel option in response to changing the display of the navigation user interface to a different view and/or physical location from the first view of the first physical location. In some embodiments, the computer system ceases to display the travel option when the computer system determines no change to display the navigation user interface with the second level of immersion corresponding to the second view of the second physical location (e.g., no selection of a respective travel user interface element since initiating display of the navigation user interface).

In some embodiments, while displaying the navigation user interface with the second level of immersion corresponding to the second view of the second physical location, the computer system detects, via the one or more input devices, a third input directed to the travel option, such as user input 718c directed to travel user interface object 720a in FIG. 7C. For example, the third input includes a gaze of the user, a contact on a touch-sensitive surface, actuation of a physical input device, a predefined gesture (e.g., pinch gesture or air tap gesture) and/or a voice input from the user directed to the travel option.

In some embodiments, in response to detecting the third input, the computer system changes the display of the navigation user interface with the second level of immersion corresponding to the second view of the second physical location to correspond to the first view of the first physical location, such as changing from navigation user interface 704b in FIG. 7C to navigation user interface 704b in FIG. 7D. For example, in response to detecting the third input, the computer system displays the previous view of the respective physical location. In some embodiments, the computer system maintains the level of immersion. In some embodiments, displaying the previous view of the respective physical location includes displaying a second travel option that, when selected, causes the computer system to display the recently displayed view of the respective physical location that was displayed prior to displaying the previous view of the respective physical location. For example, selecting the second travel option causes the computer system to optionally change from displaying the navigation user interface with the second level of immersion corresponding to the first view of the first physical location to the navigation user interface with the second level of immersion corresponding to the second view of the second physical location. Providing an option to display the previous view of the respective physical location provides quick display of the previous view of the respective physical location without requiring the user to traverse a map, thereby reducing the number of inputs and providing more efficient interactions between the user and the computer system.

In some embodiments, while displaying the navigation user interface corresponding to the first view of the first physical location, the computer system displays, via the display generation component, a first navigation user interface element within the three-dimensional environment, wherein the first navigation user interface element represents a third view of the first physical location and includes an indication of a second computer system (e.g., associated with a user that is different from the user of the computer system) at a respective location within the first navigation user interface element corresponding to a current location of the second computer system within the first physical location, such as travel user interface object 720e. In some embodiments, the first navigation user interface element includes one or more characteristics of the first navigation user interface element described above. In some embodiments, the computer system receives an indication (e.g., from the second computer system, from a server) of the current location of the second computer system within the first physical location. For example, the user of the computer system and the user of the second computer system are connected via a service that presents the locations of the second computer system to the computer system and the location of the computer system to the second computer system. In some embodiments, as the second computer system moves such that the current location of the second computer system changes, the computer system updates the display of the first navigation user interface element to move and/or change the indication of the second computer system to correspond to the changed current location of the second computer system.

In some embodiments, while displaying the first navigation user interface element including the indication of the second computer system within the first navigation user interface element, the computer system detects, via the one or more input devices, a second input directed to the indication of the second computer system, such as user input 718c directed to travel user interface object 720e in FIG. 7C. For example, the second input includes a gaze of the user, a contact on a touch-sensitive surface, actuation of a physical input device, a predefined gesture (e.g., pinch gesture or air tap gesture) and/or a voice input from the user directed to the indication of the second computer system.

In some embodiments, in response to detecting the second input, the computer system changes the display of the navigation user interface with the second level of immersion corresponding to the first view of the first physical location to correspond to a respective view from the current location of the second computer system, such as changing from navigation user interface 704b in FIG. 7C to navigation user interface 704b in FIG. 7D. In some embodiments, changing the display of the navigation user interface with the second level of immersion to correspond to the respective view of the current location of the second computer system includes displaying an image taken from the current location of the second computer system, different from the first physical location. In some embodiments, the image includes a plurality of images and/or video content associated with the current location of the second computer system (e.g., captured by the second computer system or by a different electronic device). In some embodiments, changing the display of the navigation user interface with the second level of immersion to correspond to the respective view of the current location of the second computer system includes the computer system displaying (e.g., live) video recorded at the current location of the second computer system. For example, the video recorded is captured by (e.g., one or more cameras and/or microphones in communication with) the second computer system. Changing the display of the navigation user interface to correspond to a respective view from the current location of the second computer system provides an efficient way of viewing a respective view corresponding to the location of the second computer system without having to leave the navigation user interface, thereby reducing the need for subsequent inputs to search for the current location of the second computer system which simplifies the interaction between the user and the computer system and enhances the operability of the computer system and makes the user-computer system interface more efficient.

In some embodiments, while displaying the navigation user interface corresponding to the first view of the first physical location, the computer system displays, via the display generation component, a first navigation user interface element within the three-dimensional environment, wherein the first navigation user interface element represents a third view of the first physical location and includes additional content corresponding to the first physical location, such as representation 722a of a business located within the third view of the first physical location in FIG. 7C. In some embodiments, the first navigation user interface element includes one or more characteristics of the first navigation user interface element described above. In some embodiments, the additional content corresponding to the first physical location includes information corresponding to one or more points of interest (e.g., landmark, public park, structure, business, or other entity that is of interest to the user). For example, when the point of interest corresponds to a business, the additional content includes the name of the business, the address of the business, category of business, distance to the business, and/or other information associated with the business. In some embodiments, the additional content includes virtual objects, that when selected, initiates communication with the business and/or navigates to an application or website associated with the business. In some embodiments, the computer system displays the additional content in a respective location of the first navigation user interface element (e.g., within, proximate to, overlaid on, etc. the respective physical location of the business). In some embodiments, the computer system displays the additional content overlaid on a virtual object or physical object within the physical environment surrounding the computer system, such as a wall or any other surface. In some embodiments, the computer system presents the additional content in response to user input corresponding to selection of a virtual object within the first navigation user interface element that corresponds to the business. In some embodiments, the virtual object is displayed proximate to a respective location within the first navigation user interface element corresponding to the physical location of the business within the first physical location. In some embodiments, the computer system displays the additional content within the navigation user interface. In some embodiments, the number and/or amount of additional content displayed within the navigation user interface is based on a level of immersion. For example, the second level of immersion includes a larger, smaller, or the same number of additional content than the first level of immersion. Displaying additional content corresponding to the first physical location provides an efficient way of viewing additional content corresponding to the first physical location without having to leave the navigation user interface, thereby reducing the need for subsequent inputs to search for additional content corresponding to the first physical location which simplifies the interaction between the user and the computer system and enhances the operability of the computer system and makes the user-computer system interface more efficient.

In some embodiments, while displaying the navigation user interface corresponding to the first view of the first physical location, the computer system displays, via the display generation component, a first navigation user interface element within the three-dimensional environment that, represents a third view of the first physical location and includes additional content corresponding to a weather condition at the first physical location, such as an indication 712 of weather in FIG. 7G. In some embodiments, the first navigation user interface element includes one or more characteristics of the first navigation user interface element described above. In some embodiments, the additional content corresponding to the weather condition at the first physical location includes indications (and/or representations) of precipitation, clouds, sunshine, wind, fog, and/or haze at the first physical location at which the weather condition is occurring, has occurred, or is forecasted to occur. In some embodiments, the additional content indication is a pictorial representation of the weather condition displayed at a location in the first navigation user interface element. For example, when the first physical location is experiencing rain, the computer system displays a representation of a raincloud and rain at the respective location within the first navigation user interface element corresponding to the first physical location experiencing the rain. In some embodiments, in addition to displaying the pictorial representation, the computer system displays a text description of the weather condition, such as forecast conditions, temperature, ultraviolet index, wind information, and/or other weather measurement. In some embodiments, the computer system displays the additional content within the navigation user interface. Displaying additional content corresponding to weather conditions at the first physical location provides an efficient way of viewing additional content corresponding to the first physical location without having to leave the navigation user interface, thereby reducing the need for subsequent inputs to search for weather conditions at physical locations which simplifies the interaction between the user and the computer system and enhances the operability of the computer system and makes the user-computer system interface more efficient.

In some embodiments, while displaying the navigation user interface corresponding to the first view of the first physical location, the computer system detects a second input that corresponds to a request to change a zoom level of the first view of the first physical location, such as inputs 738 corresponding to a request 740i to change a zoom level in FIG. 7I. For example, the second input includes a gaze of the user, a contact on a touch-sensitive surface, actuation of a physical input device, a predefined gesture (e.g., pinch gesture or air tap gesture) and/or a voice input from the user corresponding to the request to change the zoom level. In some embodiments, the second input is directed to the navigation user interface. In some embodiments, the second input is directed to a user interface element that, when selected initiates the process to change the zoom level as described herein. In some embodiments, the computer system initially displays the respective content of the navigation user interface corresponding to the first view of the first physical location with one or more characteristics of the first perspective from the simulated camera described above.

In some embodiments, in response to detecting the second input, and in accordance with a determination that the request to change the zoom level corresponds to changing the zoom level by a first amount, the computer system displays, via the display generation component, a first navigation user interface element within the three-dimensional environment that represents a third view of the first physical location, such as navigation user interface element 714 in FIG. 7J. In some embodiments, the zoom level by a first amount is based on a magnitude (e.g., of speed, distance, and/or duration) of the second input. For example, the second input is optionally a pinch to zoom gesture while attention of the user is directed to the navigation user interface (e.g., a predetermined portion of the respective content and/or a virtual object within the navigation user interface selectable to change the zoom level) while a hand of the user performs a pinch air gesture that includes the tips of the thumb and index fingers of the hand coming together and touching, or the index finger in direct interaction with the virtual object within the navigation user interface selectable to change the zoom level (e.g., air tapping or air touching), or while two hands of the user come together towards each other (e.g., to zoom out of the respective content of the navigation user interface) or away from each other (e.g., to zoom into the respective content of the navigation user interface). In some embodiments, the first navigation user interface element includes one or more characteristics of the first navigation user interface element described above. For example, the computer system initially displays the first navigation user interface element with a first zoom level appropriate for the first physical location, such that the first navigation user interface element is centered on an area and/or portion associated with the first physical location (e.g., without changing the viewpoint of the user of the computer system). In some embodiments, the computer system changes the zoom level in response to voice input from the user corresponding to the request to change the zoom level of the first view of the first physical location.

In some embodiments, and in accordance with a determination that the request to change the zoom level corresponds to changing the zoom level by a second amount, different from the first amount, the computer system changes the display of the first navigation user interface element from representing the third view of the first physical location to a fourth view of the first physical location, such as changing from navigation user interface element 714 in FIG. 7J to navigation user interface element 714 in FIG. 7K. In some embodiments, the view of the first navigation user interface element changes depending on the level of zoom (e.g., amount of zoom) applied to the first navigation user interface element in response to the inputs as described herein. In some embodiments, the zoom level by the second amount is greater than the zoom level by the first amount. In some embodiments, the zoom level by the second amount is less than the zoom level by the first amount. For example, when the computer system determines that the amount of zoom causes the level of zoom to be lower than a first threshold, the computer system optionally displays a second navigation user interface element that is described below. As another example, when the level of zoom is between the first threshold and a second threshold greater than the first threshold, the computer system displays the first navigation user interface element. In some embodiments, when the level of zoom is greater than the second threshold, the computer system displays the respective content. In some embodiments, when the first navigation user interface element represents the fourth view of the first physical location, the first navigation user interface element is centered on a second area and/or second portion associated with the first physical location that is the same, larger, or smaller than the area and/or portion associated with the first physical location when the first navigation user interface element represented the third view of the first physical location (e.g., prior to the second input to change the zoom level by a second amount). For example, when the first navigation user interface element represents the fourth view of the first physical location, the first navigation user interface element includes natural features (e.g., landforms, plants, etc.), optionally without showing manmade features (e.g., buildings, infrastructure, etc.) that are displayed when the first navigation user interface element represents the third view of the first physical location.

In some embodiments, and in accordance with a determination that the request to change the zoom level corresponds to changing the zoom level by a third amount, different from the first amount and different from the second amount, the computer system displays, via the display generation component, a second navigation user interface element within the three-dimensional environment, wherein the second navigation user interface element represents a first portion corresponding to the first physical location, such as navigation user interface element 754 in FIG. 7N. In some embodiments, the view of the first navigation user interface element changes depending on the level of zoom (e.g., amount of zoom) applied to the first navigation user interface element in response to the inputs as described herein. In some embodiments, the third amount is greater than or less than the second amount. For example, when the computer system determines that the third amount of zoom causes the level of zoom to be lower than the first threshold, the computer system optionally displays the second navigation user interface element that represents the first portion corresponding to the first physical location. In some embodiments, the second navigation user interface element is a three-dimensional globe centered on an area and/or portion associated with the first physical location (e.g., without changing the viewpoint of the user of the computer system). For example, the second navigation user interface element representing the first portion corresponding to the first physical location optionally includes a view of North America and South America. Providing the ability to zoom in or out to see greater detail and/or a larger area corresponding to the first physical location in response to user input provides an efficient way of viewing a respective view corresponding to the first physical location which simplifies the interaction between the user and the computer system and enhances the operability of the computer system and makes the user-computer system interface more efficient.

In some embodiments, while displaying the second navigation user interface element including the first portion corresponding to the first physical location, the computer system detects a third input that corresponds to a request to change the zoom level of the first portion, such as user input 738 corresponding to a request 740k to change the zoom level in FIG. 7K. In some embodiments, the third input includes one or more characteristics of the second input described above.

In some embodiments, in response to detecting the third input, and in accordance with a determination that the request to change the zoom level corresponds to changing the zoom level by a fourth amount, the computer system changes the display of the second navigation user interface element from representing the first portion of the first physical location to a second portion of the first physical location, such as for example, zooming in on the portion of navigation user interface element 754 in FIG. 7O. In some embodiments, the view of the second navigation user interface element changes depending on the level of zoom (e.g., amount of zoom) applied to the second navigation user interface element in response to the inputs as described herein. In some embodiments, the fourth amount is greater than the third amount. In some embodiments, the fourth amount is less than the third amount. In some embodiments, when the second navigation user interface element represents the second portion of the first physical location, the second navigation user interface element is centered on a second area and/or second portion associated with the first physical location that is the same, larger, or smaller than the area and/or portion associated with the first physical location when the second navigation user interface element represented the first portion of the first physical location (e.g., prior to the third input to change the zoom level by a fourth amount). For example, the second portion optionally includes a view of North America as compared to when the second navigation user interface element representing the first portion corresponding to the first physical location optionally includes a view of North America and South America. In some embodiments, in response to detecting the third input, the computer system ceases to display the second navigation user interface element.

In some embodiments, in accordance with a determination that the request to change the zoom level corresponds to changing the zoom level by a fifth amount, different from the fourth amount, the computer system displays, via the display generation component, the first navigation user interface element within the three-dimensional environment that represents the third view of the first physical location, such as navigation user interface element 714 in FIG. 7M. In some embodiments, the fifth amount is greater than or less than the fourth amount. In some embodiments, the first navigation user interface element within the three-dimensional environment that represents the third view of the first physical location includes one or more characteristics of the first navigation user interface element within the three-dimensional environment that represents the third view of the first physical location described above.

In some embodiments, and in accordance with a determination that the request to change the zoom level corresponds to changing the zoom level by a sixth amount, different from the fourth amount and different from the fifth amount, the computer system displays a respective content corresponding to the first view of the first physical location, such as navigation user interface 704b in FIG. 7F. In some embodiments, the sixth amount is greater than or less than the fifth amount. In some embodiments, the respective content corresponding to the first view of the first physical location includes one or more characteristics of the respective content corresponding to the first view of the first physical location described above. In some embodiments, the computer system ceases to display the first navigation user interface element and/or the second navigation user interface element when displaying the respective content corresponding to the first view of the first physical location. Providing the ability to zoom in or out to see greater detail and/or a larger area corresponding to the first physical location in response to user input provides an efficient way of viewing a respective view corresponding to the first physical location which simplifies the interaction between the user and the computer system and enhances the operability of the computer system and makes the user-computer system interface more efficient.

In some embodiments, while displaying the first navigation user interface element that represents the third view of the first physical location, the computer system displays the first navigation user interface element within a first (e.g., simulated physical) volume of the three-dimensional environment, such as navigation user interface element 714 in FIG. 7I. For example, the first navigation user interface element that represents the third view of the first physical location encompasses a region of the three-dimensional environment having a predefined first volume appropriate for the first physical location, such that the first navigation user interface element is centered on an area and/or portion associated with the first physical location and includes all map elements (e.g., manmade features and/or natural features described above). In some embodiments, the computer system changes the volume of the first navigation user interface element as described below to display more or less map elements and/or at a greater or lesser level of detail than when displaying the first navigation user interface element within the first amount.

In some embodiments, while displaying the respective content corresponding to the first view of the first physical location, the computer system displays the respective content in a second (e.g., simulated physical) volume of the three-dimensional environment larger than the first volume in at least one dimension, such as navigation user interface element 714 in FIG. 7J. For example, the second volume is larger in height and/or width than the first volume. In some embodiments, the computer system changes the volume of the respective content as described above with respect to the level of immersion. Displaying the respective content of the navigation user interface in a volume larger than the volume associated with the first navigation user interface element within the three-dimensional environment frees up space for display in the navigation user interface, and reduces clutter.

In some embodiments, wherein detecting the second input includes detecting a change in a posture of a user of the computer system, such as the posture of the user 734 in FIG. 7G (e.g., the user leaning in towards the first navigation user interface element or leaning away from the first navigation user interface element) that satisfies one or more criteria as described below with respect to at least a portion of the user (e.g., the position of the head of the user indicates that the head of the user is within a predetermined distance e.g., 1, 2, 3, 4, 5, 10, 20, 30, 40, 50, 60, 70, 80, 90, 100 or 200 centimeters of the first navigation user interface element). For example, the computer system optionally detects a magnitude and/or degree of change in the posture of the user (e.g., amount of head movement leaning closer to the first navigation user interface element or leaning back further away from the first navigation user interface element), and in response, the computer system updates the zoom level of the first navigation user interface element accordingly. For example, as the posture of the user indicates the head of the user moving closer to the first navigation user interface element, the computer system zooms in more than before detecting the change in posture. In another example, as the posture of the user indicates the head of the user moving further away from the first navigation user interface element, the computer system zooms out (or zooms less) than when the posture of the user indicates the head of the user moving closure to the first navigation user interface element. In some embodiments, changes in posture that do not satisfy the one or more criteria do not cause the computer system to change the zoom level of the first navigation user interface element. In some embodiments, changes in posture other than leaning towards or away the first navigation user interface element do not cause the computer system to change the zoom level of the first navigation user interface element. Changing the zoom level in response to detecting a change in a posture of the user provides an intuitive way of zooming in and out of the first navigation user interface element (e.g., without manipulating a physical input device), which additionally reduces power usage and improves battery life of the computer system by enabling the user to use the computer system more quickly and efficiently.

In some embodiments, while displaying the first navigation user interface element representing the third view of the first physical location, the computer system detects the change in the posture of the user of the computer system that satisfies the one or more criteria, such as the posture of the user 734 in FIG. 7H. In some embodiments, detecting the change in the posture of the user of the computer system that satisfies the one or more criteria includes one or more characteristics of detecting the change in the posture of the user of the computer system that satisfies the one or more criteria described above.

In some embodiments, in response to detecting the change in the posture of the user of the computer system that satisfies the one or more criteria, and in accordance with a determination that the change in the posture of the user of the computer system includes a first predetermined pose, the computer system scales the third view of the first physical location by a first amount, such as the first navigation user interface element 714 in Figure G. For example, the first predetermined pose includes the position of the head of the user within a second predetermined distance e.g., 50, 60, 70, 80, 90, 100 or 200 centimeters of the first navigation user interface element. In some embodiments, scaling the third view of the first physical location by the first amount includes zooming in the third view by a first scaling value (e.g., 110, 120, 130, 140, or 150% of its original size) prior to detecting the change in the posture of the user by the first amount. In some embodiments, scaling the third view of the first physical location by the first amount includes displaying map elements at a larger or smaller size in accordance with the change in the posture of the user of the computer system that satisfies the one or more criteria.

In some embodiments, in accordance with a determination that the change in the posture of the user of the computer system includes a second predetermined pose, different from the first predetermined pose, the computer system scales the third view of the first physical location by a second amount, different from the first amount, such as the first navigation user interface element 714 in FIG. 7H. For example, the second predetermined pose includes the position of the head of the user within a second predetermined distance e.g., 1, 2, 4, 6, 8 10, 20, 30, 40 or 50 centimeters of the first navigation user interface element. In some embodiments, scaling the third view of the first physical location by the second amount includes zooming in the third view by a second scaling value, greater than the first scaling value, such as 150, 160, 170, 180, or 200% of its original size prior to detecting the change in the posture of the user by the second amount. In some embodiments, scaling the third view of the first physical location by the second amount includes displaying map elements at a larger size than when scaled by the first amount. Changing the scaling of the third view of the first physical location in response to detecting a predetermined pose of the user provides an intuitive way of zooming in and out of the first navigation user interface element (e.g., without manipulating a physical input device), which additionally reduces power usage and improves battery life of the computer system by enabling the user to use the computer system more quickly and efficiently.

In some embodiments, while displaying the first navigation user interface element representing the third view of the first physical location, the computer system detects the change in the posture of the user of the computer system that satisfies the one or more criteria, such as the posture of the user 734 in FIG. 7H. In some embodiments, detecting the change in the posture of the user of the computer system that satisfies the one or more criteria includes one or more characteristics of detecting the change in the posture of the user of the computer system that satisfies the one or more criteria described above.

In some embodiments, in response to detecting the change in the posture of the user of the computer system that satisfies the one or more criteria, and in accordance with a determination that the change in the posture of the user of the computer system includes a first predetermined pose, the computer system displays the third view of the first physical location with a first level of detail, such as a level of detail shown by navigation user interface element 714 in FIG. 7H. In some embodiments, the first predetermines pose includes one or more characteristics of the first predetermined pose described above. In some embodiments and as described above, scaling the third view by a respective scaling value includes displaying a larger or smaller first navigation user interface element. In some embodiments, displaying the third view of the first physical location with the first level of detail includes the first physical area with more detail than a level of detail of the third view without detecting the first predetermined pose. For example, displaying the third view of the first physical location with the first level of detail includes buildings, landmarks, parks, and/or lanes of roads that is optionally not included in the third view without detecting the first predetermined pose.

In some embodiments, in accordance with a determination that the change in the posture of the user of the computer system includes a second predetermined pose, different from the first predetermined pose, the computer system displays the third view of the first physical location with a second level of detail, different from the first level of detail, such as a level of detail shown by navigation user interface element 714 in FIG. 7I. In some embodiments, the second predetermines pose includes one or more characteristics of the second predetermined pose described above. In some embodiments, displaying the third view of the first physical location with the second level of detail includes displaying the first physical area with more detail than a level of detail of the third view with the first level of detail. For example, displaying the third view of the first physical location with the second level of detail includes buildings, landmarks, parks, and/or lanes of roads, trees, foliage, sidewalks, bike lanes, medians, and/or cross walks that is optionally not included in the first level of detail. Changing the level of detail of the first physical location in response to detecting a predetermined pose of the user provides an intuitive way of zooming in and out of the first navigation user interface element (e.g., without manipulating a physical input device), which additionally reduces power usage and improves battery life of the computer system by enabling the user to use the computer system more quickly and efficiently.

In some embodiments, detecting the second input that corresponds to a request to zoom includes detecting a change in a viewpoint of a user of the computer system that satisfies one or more criteria, such as the viewpoint of the user 734 in FIG. 7G. For example, detecting that the user of the computer system has moved locations within the physical environment. In some embodiments, the computer system determines an angle of view of a viewpoint of the user of the computer system (e.g., viewing angle) formed from a first vector extending normal from a respective portion (e.g., a center) of the first navigation user interface element and a second, different vector extending from the respective portion of first navigation user interface element toward the viewpoint of the user (e.g., the user's field-of-view, a center of the user's head, and/or a center of the computer system). For example, the viewing angle is between the viewpoint of the user and the first navigation user interface element. In some embodiments, the computer system detects that the change in the angle of view of a viewpoint of the user of the computer system satisfies the one or more criteria (e.g., within a range of angles, such as 5, 10, 15, 20, 25, 30, 35, 40, 45, 50, 55, 60, 65, 70, or 75 degrees relative to the normal of the first navigation user interface element).

In some embodiments, in response to detecting the change in the viewpoint of the user of the computer system that satisfies the one or more criteria, and in accordance with a determination that the change in the viewpoint of the user includes movement along a first axis, the computer system changes the zoom along a second axis corresponding to the first axis, such as shown with navigation user interface element 714 in FIG. 7G. In some embodiments, the first axis is the same as the second axis. In some embodiments, the first axis is different from the second axis. For example, the first predetermined viewpoint optionally includes a first viewing angle (e.g., 25, 30, 35, 40, 45, 50, 55, 60, 65, 70, or 75 degrees from the normal) and a zoom axis that corresponds to the first viewing angle. In some embodiments, changing the zoom along a second axis corresponding to the first axis includes one or more characteristics of displaying the third view from the first zoom level described above.

In some embodiments, in accordance with a determination that the change in the viewpoint of the user includes movement along the second axis, the computer system changes the zoom along the first axis corresponding to the second axis, such as shown with navigation user interface element 714 in FIG. 7H. For example, the second predetermined viewpoint optionally includes a second viewing angle that is less than the first viewing angle, such as 5, 10, 15, 20, 25, 30, 35, 40, 45, 50, 55, or 60 degrees from the normal and the zoom axis that corresponds to the second viewing angle. In some embodiments, changing the zoom along the first axis corresponding to the second axis includes one or more characteristics of displaying the third view from the second zoom level described above. In another example, while the computer system displays a first portion of the first navigation user interface element from a first zoom level corresponding to a first viewing angle relative to the first navigation user interface element, the computer system determines a change from the first viewing angle to a second viewing angle relative to the first navigation user interface element, different from the first viewing angle. In response to the change from the first viewing angle to the second viewing angle, the computer system displays the same portion of the first navigation user interface element from a second zoom level, different from the first zoom level. In some embodiments, the computer system zooms into a given location in the first navigation user interface element-optionally for the same amount of head movement-when the viewing angle into that given location is different during the head movement (e.g., a first viewing angle into that location from a first viewpoint when the head movement begins results in zooming along a first axis (e.g., perpendicular to the first viewing angle), and a second viewing angle into that location from a second viewpoint when the head movement begins results in zooming along a second axis (e.g., perpendicular to the second viewing angle), different from the first axis). Changing the zoom level of the third view of the first physical location in accordance with a determination that a change in the viewpoint of the user includes a respective predetermined viewpoint improves visual feedback about user position relative to the first navigation user interface element, thereby informing the user as to how subsequent changes may impact the level of detail of the respective view of the first physical location, which reduces errors in interaction with the computer system, and enhances the operability of the computer system and makes the user-computer system interface more efficient.

In some embodiments, in response to detecting the second input, and in accordance with a determination that a location of a gaze of a user of the computer system is directed to a first portion of the first navigation user interface element, such as gaze 728 in FIG. 7G while detecting the second input, the computer system changes the zoom level along a first axis in accordance with the first portion of the first navigation user interface element, such as shown by navigation user interface element 714 in FIG. 7G to navigation user interface element 714 in FIG. 7H. For example, the computer system determines that a gaze of the user has been directed to the first navigation user interface element for an amount of time exceeding a predetermined time threshold (e.g., 0.05, 0.1, 0.2, 0.3, 0.5, 1, 2, 5, 10, 20, or 30 seconds) while detecting the second input that corresponds to a request to change a zoom level, and in response, the computer system zooms into the first portion of the first navigation user interface element. In some embodiments, while the computer system zooms into the first portion of the first navigation user interface element (e.g., the portion of the first navigation user interface element towards which the gaze of the user is directed), the first portion of the first navigation user interface element remains at a fixed position in the three-dimensional environment (and the computer system optionally moves other portions of the first navigation user interface element in the three-dimensional environment to accomplish this result, as needed). In some embodiments, the computer system continues to increase the level of zoom in accordance with the duration of the gaze of the user directed to the first portion of the first navigation user interface element. In some embodiments, the first portion that is a target of the gaze of the user is rendered in higher quality, definition/resolution than other portions of the first navigation user interface element which are rendered in lower quality. In some embodiments, as the computer system detects continued gaze of the user directed to the first portion of the first navigation user interface element, the computer system continues to zoom in on the first portion of the first navigation user interface element. In some embodiments, zooming in or out of the first portion requires head movement, as described previously.

In some embodiments, in accordance with a determination that a location of a gaze of a user of the computer system is directed to a second portion of the first navigation user interface element while detecting the second input different from the first portion of the first navigation user interface element, the computer system changes the zoom level along a second axis in accordance with the second portion of the first navigation user interface element different from the first axis, such as shown by navigation user interface element 714 in FIG. 7H to navigation user interface element 714 in FIG. 7I. For example, the computer system determines that a gaze of the user has moved from away from the first portion to a second portion of the first navigation user interface element and in response, the computer system zooms into the second portion of the first navigation user interface element. In some embodiments, the computer system changes the position of the first navigation user interface element such that such that the first navigation user interface element is centered on the second portion. In some embodiments, while the computer system zooms into the second portion of the first navigation user interface element (e.g., the portion of the first navigation user interface element towards which the gaze of the user is directed), the second portion of the first navigation user interface element remains at a fixed position in the three-dimensional environment (and the computer system optionally moves other portions of the first navigation user interface element in the three-dimensional environment to accomplish this result, as needed). In some embodiments, the computer system continues to increase the level of zoom in accordance with the duration of the gaze of the user directed to the second portion of the first navigation user interface element. In some embodiments, the second portion that is a target of the gaze of the user is rendered in higher quality, definition/resolution than the first portion that is no longer the target of the gaze of the user such that the first portion is rendered in lower quality. In some embodiments, as the computer system detects continued gaze of the user directed to the second portion of the first navigation user interface element, the computer system continues to zoom in on the second portion of the first navigation user interface element. In some embodiments, zooming in or out of the second portion requires head movement, as described previously. Changing the zoom level in response to detecting a change in the location of the gaze of the user provides an intuitive way of zooming in and out of the first navigation user interface element (e.g., without manipulating a physical input device), which additionally reduces power usage and improves battery life of the computer system by enabling the user to use the computer system more quickly and efficiently.

In some embodiments, while displaying the first navigation user interface element representing the third view of the first physical location, the computer system detects a third input that corresponds to a request to update a position and/or an orientation of the first navigation user interface element within the three-dimensional environment, such as inputs 738 corresponding to a request 740i to update a position and/or an orientation of the first navigation user interface element in FIG. 7I. In some embodiments, the third input includes a gaze of the user, a contact on a touch-sensitive surface, actuation of a physical input device, a predefined gesture (e.g., pinch gesture or air tap gesture) and/or a voice input from the user corresponding to the request to update a position and/or an orientation of the first navigation user interface element within the three-dimensional environment. For example, the computer system initially displays the first navigation user interface element with a first position and/or orientation appropriate for the first physical location, such that the first navigation user interface element is centered on an area and/or portion associated with the first physical location. In some embodiments, the third input is directed to the first navigation user interface element. In some embodiments, the third input is directed to a control element for adjusting the position and/or orientation of the first navigation user interface element, described in further detail below.

In some embodiments, in response to detecting the third input, the computer system changes the position and/or the orientation of the first navigation user interface element within the three-dimensional environment based on the third input, such as changing from the navigation user interface element 714 in FIG. 7I to the navigation user interface element 14 in FIG. 7J. In some embodiments, when the computer system changes the position and/or the orientation of the first navigation user interface element within the three-dimensional environment based on the third input, the computer system displays the first navigation user interface element with a second position and/or orientation appropriate for a second physical location, different from the first physical location such that the first navigation user interface element is rotated and/or positioned to be centered on an area and/or portion associated with the second physical location. In some embodiments, changing the position and/or orientation of the first navigation user interface element is based on one or more characteristics of the third input (e.g., speed, distance, and/or duration). For example, when the third input includes a request to move the first navigation user interface element in a first direction (e.g., left, right, up, down, forwards, backwards, or any combination of the aforementioned), the computer system moves the first navigation user interface element accordingly. In another example, when the third input includes a request to move the first navigation user interface element with a first speed from a first location to a second location, the computer moves the first navigation user interface element accordingly, with a speed corresponding to the first speed from the first location to the second location in the three-dimensional environment. In some embodiments, the computer system rotates the first navigation user interface element in response to a duration of the third input. For example, when the duration is for a first amount of time, the computer system rotates the first navigation user interface element for a time that corresponds to the first amount of time. Changing the position and/or the orientation in response to detecting an input of the user provides an intuitive way of rotating and/or changing the orientation of the first navigation user interface element (e.g., without manipulating a physical input device), which additionally reduces power usage and improves battery life of the computer system by enabling the user to use the computer system more quickly and efficiently.

In some embodiments, the first navigation user interface element is displayed in a respective volume within the three-dimensional environment and includes a control (e.g., rotation and/or resizing) element that is interactive to rotate the first navigation user interface element, such as selectable user interface control element 716 in FIG. 7I. In some embodiments, the first navigation user interface element encompasses a region of the three-dimensional environment having a predefined respective volume that is constrained by a portal or other boundary as described above. In some embodiments, the first navigation user interface element is position along the control element, wherein the control element is optionally capable of being within the portal and/or outside the portal. In some embodiments, the computer system detects input directed to the control element such as a gaze of the user, a contact on a touch-sensitive surface, actuation of a physical input device, a predefined gesture (e.g., pinch gesture or air tap gesture) and/or a voice input from the user corresponding to a request to rotate the first navigation user interface element, and in response, the computer system rotates the first navigation user interface element within the three-dimensional environment as described above and below. In some embodiments, the input directed to the control element corresponds to a request to scale the first navigation user interface element, and in response, the computer system scales the first navigation user interface element as described with respect to scaling the first navigation user interface element by a respective amount described above.

In some embodiments, scaling the first navigation user interface element includes scaling the control element. In some embodiments, the input directed to the control element corresponds to a request to rotate the first navigation user interface element. For example, the control element optionally resembles a ring that is interactable to stretch, resize, and/or rotate. In some embodiments, when the computer system detects that the input is directed to a first portion of the control element (e.g., inner portion of the ring, such as 716j in FIG. 7J), the computer system, in response, rotates the first navigation user interface element a first amount (e.g., 10, 20, 30, 40, 50, or 60 degrees of rotation). In some embodiments, when the computer system detects that the input is directed to a second portion of the control element, different from the first portion, such as an outer portion of the ring, such as 716k in FIG. 7K, the computer system, in response, rotates the first navigation user interface element a second amount, less than the first amount (e.g., 2, 3, 5, 10, 20, or 30 degrees of rotation). In some embodiments, the computer system presents an audio indication of the amount of rotation (e.g., clicking sound every 1, 5, or 15 degrees of rotation). In some embodiments, the computer system ceases to display the control element when the computer system displays the second navigation user interface element or when the computer system displays the navigation user interface with the second level of immersion. Displaying a control element interactable to rotate the first navigation user interface element provides an intuitive and visible way of rotating the first navigation user interface element (e.g., without manipulating a physical input device), which additionally reduces power usage and improves battery life of the computer system by enabling the user to use the computer system more quickly and efficiently.

In some embodiments, while displaying the first navigation user interface element representing the third view of the first physical location and while displaying the control element at a first size, the computer system detects a third input directed to the control element, such as inputs 738 directed to the selectable user interface control element 716 in FIG. 7I. In some embodiments, the third input includes a gaze of the user, a contact on a touch-sensitive surface, actuation of a physical input device, a predefined gesture (e.g., pinch gesture or air tap gesture) and/or a voice input from the user directed to the control element.

In some embodiments, in response to detecting the third input, the computer system scales the respective volume in which the first navigation user interface element is displayed to represent a fourth view of the first physical location in accordance with the third input and scaling the control element to a second size, different from the first size, in accordance with the third input, such as changing the navigation user interface element 714 in FIG. 7I to the navigation user interface element 714 in FIG. 7J. In some embodiments, as described above the first navigation user interface element including the control element encompasses a region of the three-dimensional environment having a predefined respective volume that is constrained by a portal or other boundary. In some embodiments, scaling the respective volume in which the first navigation user interface element is displayed includes zooming the third view by a respective scaling value as described above. In some embodiments, the fourth view of the first physical location includes one or more characteristics of displaying the fourth view of the first physical location as described above. In some embodiments, scaling the control element to the second size includes a size larger or smaller than the first size of the control element prior to detecting the third input. In some embodiments, scaling the control element to the second size includes stretch and/or enlarging the control element by a first scaling value (e.g., 110, 120, 130, 140, or 150% of its original size). In some embodiments, scaling the control element to the second size does not include zooming in or out of the first navigation user interface element. Accordingly, the first navigation user interface element maintains its own scaling value and does not change as the control element changes scale. Accordingly, the computer system displays a larger portion of the first navigation user interface element in response to scaling the control element to a size larger than before detecting the third input. For example, prior to the input to scale the control element, the computer system optionally displayed a portion of a map element (e.g., building, landmark, or other point of interest) because that element was being clipped by the control element, and in response to the input to scale the control element, the computer system optionally displays the map element in its entirety.

In some embodiments, scaling the control element corresponds to scaling the volume in which the first navigation user interface element is bound by as described above with reference to the volume associated with the first navigation user interface element. In some embodiments, the computer system scales the control element in accordance with a duration of the third input. For example, when the third input includes a duration of a first amount, the computer system scales the first navigation user interface element by a first scaling value corresponding to the first amount. In some embodiments, when the third input includes a first direction corresponding to scaling the first navigation user interface element horizontally or vertically, the computer system applies a first scaling value in a first direction corresponding to the first direction of the third input. Displaying a control element interactable to scale the respective volume in which the first navigation user interface element including the control element is displayed provides an intuitive and visible way of scaling the first navigation user interface element (e.g., without manipulating a physical input device), which additionally reduces power usage and improves battery life of the computer system by enabling the user to use the computer system more quickly and efficiently.

In some embodiments, while displaying the first navigation user interface element representing the third view of the first physical location and while displaying the control element at a first size, the computer system detects a third input directed to the first navigation user interface element, such as inputs 738 directed to the selectable user interface control element 716 in FIG. 7I. In some embodiments, the third input includes a gaze of the user, a contact on a touch-sensitive surface, actuation of a physical input device, a predefined gesture (e.g., pinch gesture or air tap gesture) and/or a voice input from the user directed to the first navigation user interface element.

In some embodiments, in response to detecting the third input, the computer system scales the display of the third view of the first physical location to represent a fourth view of the first physical location in accordance with the third input without scaling a view volume associated with the first navigation user interface element, such as shown by navigation user interface element 714 in FIG. 7H to navigation user interface element 714 in FIG. 7I. In some embodiments, as described above the first navigation user interface element including the control element encompasses a region of the three-dimensional environment having a predefined respective volume that is constrained by a portal or other boundary. In some embodiments, scaling the respective volume in which the first navigation user interface element is displayed includes zooming the third view by a respective scaling value as described above. In some embodiments, the fourth view of the first physical location includes one or more characteristics of displaying the fourth view of the first physical location as described above. In some embodiments, scaling the first navigation user interface element to represent the fourth view of the first physical location does not include scaling the control element to the second size as described above. Displaying a control element interactable to scale the respective volume in which the first navigation user interface element is displayed without scaling the control element provides an intuitive and visible way of scaling the first navigation user interface element (e.g., without manipulating a physical input device), which additionally reduces power usage and improves battery life of the computer system by enabling the user to use the computer system more quickly and efficiently.

In some embodiments, while displaying the first navigation user interface element representing the third view of the first physical location, the computer system detects, a fourth input that corresponds to a request to change a zoom level of the third view of the first physical location, such as user input 738 corresponding to a request 740k to change the zoom level in FIG. 7K. For example, the fourth input optionally includes a gaze of the user, a contact on a touch-sensitive surface, actuation of a physical input device, a predefined gesture (e.g., pinch gesture or air tap gesture) and/or a voice input from the user corresponding to the request to change the zoom level. In some embodiments, the fourth input is directed to the first navigation user interface element or a control element of the navigation user interface element as described above.

In some embodiments, in response to detecting the fourth input, and in accordance with a determination that the request to change the zoom level corresponds to changing the zoom level to a first level, the computer system changes the display of the first navigation user interface element representing the third view of the first physical location to represent a fourth view of the first physical location and the computer system outputs, via one or more output devices in communication with the computer system, spatial audio with one or more characteristics corresponding to the fourth view of the first physical location, such as spatial audio indicators 730 and 742 in FIG. 7K. In some embodiments, the fourth view of the first physical location includes one or more characteristics of displaying the fourth view of the first physical location as described above. In some embodiments, outputting spatial audio characteristics corresponding to the fourth view of the first physical location includes spatial audio that was captured by one or more cameras and/or microphones at the first physical location and optionally from the direction corresponding to the respective direction associated with the first physical location as if emanating from a location relative to the viewpoint of the user of the computer system. In some embodiments, the spatial audio with one or more characteristics corresponding to the fourth view of the first physical location include playback volume and/or relative playback volumes for respective audio content output concurrently. In some embodiments, the spatial audio that is output includes environmental noises, urban acoustic noises, geophysical noises, animal noises, and/or traffic noises.

In some embodiments, in accordance with a determination that the request to change the zoom level corresponds to changing the zoom level to a second level, different from the first level, the computer system changes the display of the first navigation user interface element representing the third view of the first physical location to represent a fifth view of the first physical location, different from the fourth view of the first physical location, and the computer system outputs, via the one or more output devices, the spatial audio with the one or more characteristics corresponding to the fifth view of the first physical location, such as spatial audio indicators 730 and 742 in FIG. 7L. In some embodiments, the spatial audio with one or more characteristics corresponding to the fifth view of the first physical location include one or more characteristics of the spatial audio with one or more characteristics corresponding to the fourth view of the first physical location described above. In some embodiments, the one or more spatial audio characteristics vary based on the view of the physical location, such as increasing or decreasing overall playback volume, and/or relative playback volumes for respective audio content output concurrently. In some embodiments, the second zoom level includes a view of the first physical location at a greater level of detail than the fourth view of the first physical location. In some embodiments, the computer system renders the fifth view of the first physical location with higher definition/resolution than the fourth view of the first physical location. In some embodiments, outputting spatial audio characteristics corresponding to the fifth view of the first physical location includes increasing the volume of the spatial audio that was captured by one or more cameras and/or microphones at the first physical location compared to the spatial audio that was output when the first navigation user interface element represented the fourth view of the first physical location. Outputting spatial audio corresponding to a respective view of the first physical location enhances user interactions with the computer system by providing audio corresponding to the respective view of the first physical location which provides improved feedback to the user, enhances spatial awareness, and enhances the operability of the computer system and makes the user-computer system interface more efficient.

In some embodiments, while displaying the first navigation user interface element representing the third view of the first physical location and while detecting, via the one or more input devices, a location of a gaze of a user of the computer system on the first navigation user interface element, such as gaze 728 in FIG. 7H, in accordance with a determination that the location of the gaze of the user is directed to a first location, the computer system outputs, via one or more output devices in communication with the computer system, spatial audio with one or more characteristics corresponding to the first location, such as spatial audio indicator 730 in FIG. 7G. In some embodiments, the computer system detects that a gaze of the user has been directed to the first navigation user interface element for an amount of time exceeding a predetermined time threshold (e.g., 0.05, 0.1, 0.2, 0.3, 0.5, 1, 2, 5, 10, 20, or 30 seconds). In some embodiments, outputting spatial audio characteristics corresponding to the first location includes spatial audio that was captured by one or more cameras and/or microphones at the respective physical location corresponding to the first location and optionally from the direction corresponding to the respective direction associated with the first location as if emanating from a location relative to the viewpoint of the user of the computer system. In some embodiments, the spatial audio with one or more characteristics corresponding to the first location include one or more characteristics of the spatial audio described above.

In some embodiments, while displaying the first navigation user interface element representing the third view of the first physical location and while detecting, via the one or more input devices, a location of a gaze of a user of the computer system on the first navigation user interface element, such as gaze 728 in FIG. 7H, in accordance with a determination that the location of the gaze of the user is directed to a second location, the computer system outputs, via the one or more output devices, spatial audio with one or more characteristics corresponding to the second location, such as spatial audio indicator 730 in FIG. 7H. In some embodiments, outputting spatial audio characteristics corresponding to the second location includes spatial audio that was captured by one or more cameras and/or microphones at the respective physical location corresponding to the second location and optionally from the direction corresponding to the respective direction associated with the second location as if emanating from a location relative to the viewpoint of the user of the computer system. For example, the second location is different from the first location and the spatial audio that is output corresponding to the second location is optionally different from the spatial audio that is output corresponding to the first location. Outputting spatial audio corresponding to a respective location enhances user interactions with the computer system by providing audio corresponding to the corresponding respective physical location which provides improved feedback to the user, enhances spatial awareness, and enhances the operability of the computer system and makes the user-computer system interface more efficient.

In some embodiments, while displaying the first navigation user interface representing the third view of the first physical location, the computer system detects, a change to a viewpoint of a user of the computer system in the three-dimensional environment, such as the posture of the user 734 in FIG. 7G. In some embodiments, the change to the viewpoint of the user of the computer system in the three-dimensional environment includes one or more characteristics of the change to the viewpoint of the user of the computer system in the three-dimensional environment as described above.

In response to detecting the change to the viewpoint of the user, and in accordance with a determination that the viewpoint of the user is changed from the first viewpoint to a second viewpoint, different from the first viewpoint, the computer system changes the display of the first navigation user interface element representing the third view of the first physical location to represent a fourth view of the first physical location and the computer system presents, via one or more output devices in communication with the computer system, spatial audio with one or more characteristics corresponding to the fourth view of the first physical location, such as spatial audio indicator 730 in FIG. 7G. In some embodiments, the fourth view of the first physical location includes one or more characteristics of displaying the fourth view of the first physical location as described above. In some embodiments, outputting spatial audio characteristics corresponding to the fourth view of the first physical location includes spatial audio that was captured by one or more cameras and/or microphones at the first physical location and optionally from the direction corresponding to the respective direction associated with the first physical location as if emanating from a location relative to the viewpoint of the user of the computer system. In some embodiments, the spatial audio with one or more characteristics corresponding to the first location include one or more characteristics of the spatial audio described above. In some embodiments, the overall volume of the spatial audio is increased or decreased. In some embodiments, the volume of particular spatial audio noises are increased or decreased.

In some embodiments, in accordance with a determination that the viewpoint of the user is changed from the first viewpoint to a third viewpoint, different from the first viewpoint and different from the second viewpoint, the computer system changes the display of the first navigation user interface element representing the third view of the first physical location to represent a fifth view of the first physical location, different from the fourth view of the first physical location and the computer system presents, via the one or more output devices, spatial audio with one or more characteristics corresponding to the fifth view of the first physical location, different from the spatial audio with the one or more characteristics corresponding to the fourth view of the first physical location, such as spatial audio indicator 730 in FIG. 7H. In some embodiments, the fifth view of the first physical location includes one or more characteristics of displaying the fifth view of the first physical location as described above. In some embodiments, outputting spatial audio characteristics corresponding to the fifth view of the first physical location includes spatial audio that was captured by one or more cameras and/or microphones at the first physical location and optionally from the direction corresponding to the respective direction associated with the first physical location as if emanating from a location relative to the viewpoint of the user of the computer system. In some embodiments, the spatial audio with the one or more characteristics corresponding to the first location include one or more characteristics of the spatial audio described above. In some embodiments, the spatial audio with the one or more characteristics corresponding to the fourth view of the first physical location includes playback volume that is louder or softer than the spatial audio with the one or more characteristics corresponding to the third view of the first physical location. In some embodiments, the spatial audio with the one or more characteristics corresponding to the fourth view of the first physical location includes more human and/or traffic noises than the spatial audio with the one or more characteristics corresponding to the third view of the first physical location which includes more ocean noises, for example. Outputting spatial audio corresponding to a respective view of the first physical location enhances user interactions with the computer system by providing audio corresponding to the respective view of the first physical location which provides improved feedback to the user, enhances spatial awareness, and enhances the operability of the computer system and makes the user-computer system interface more efficient.

In some embodiments, in accordance with a determination that the third input corresponds to a request to update the position and/or the orientation of the first navigation user interface element in a first manner, the computer system outputs, via one or more output devices in communication with the computer system, spatial audio with one or more characteristics corresponding to the position and/or orientation of the first navigation user interface element updated in the first manner, such as audio indicators in FIG. 7K. For example, the computer system initially displays the first navigation user interface element with a first position and/or orientation (relative to the viewpoint of the user) appropriate to comfortably view the display of the first navigation user interface element. In some embodiments, when the computer system updates the position and/or the orientation of the first navigation user interface element in the first manner within the three-dimensional environment based on the third input, the computer system displays the first navigation user interface element closer or farther away than the first position and/or orientation (relative to the viewpoint of the user), such that the display of the first navigation user interface element appears smaller relative to the user's perspective than when displaying the display of the first navigation user interface element at the position and/or orientation. In this example, when the computer system displays the first navigation user interface element smaller and/or farther away from the viewpoint of the user, the computer system outputs spatial audio in a corresponding manner (e.g., lower volume than when the computer system displayed the first navigation user interface element with the first position and/or orientation). In some embodiments, the spatial audio with one or more characteristics corresponding to the position and/or orientation of the first navigation user interface element updated in the first manner include one or more characteristics of the spatial audio described above. In some embodiments, when the first navigation user interface element is positioned closer to the user of the computer system, the spatial audio includes higher playback volume. In some embodiments, when the first navigation user interface element is positioned farther from the user of the computer system, the spatial audio includes lower playback volume. In some embodiments, when the orientation of the first navigation user interface element includes a first orientation wherein a first portion of the first navigation user interface element is facing away from the user, the corresponding sound noise is output at a lower playback volume. In some embodiments, when the orientation of the first navigation user interface element includes a second orientation wherein the first portion of the first navigation user interface element is facing towards the user, the corresponding sound noise is output at a higher playback volume.

In some embodiments, in accordance with a determination that the third input corresponds to a request to update the position and/or the orientation of the first navigation user interface element in a second manner, different from the first manner, the computer system outputs, via one or more output devices in communication with the computer system, spatial audio with the one or more characteristics corresponding to the position and/or orientation of the first navigation user interface element updated in the second manner, such as audio indicators 730 and 742 in FIG. 7L. For example, the second manner in which the first navigation user interface element is positioned and/or oriented is optionally closer than the first manner in which the first navigation user interface element was positioned and/or oriented (relative to the viewpoint of the user), such that the display of the first navigation user interface element appears larger relative to the user's perspective than when displaying the display of the first navigation user interface element in the first manner. In this example, when the computer system displays the first navigation user interface element larger and/or closer to the viewpoint of the user, the computer system outputs spatial audio in a corresponding manner (e.g., louder volume than when the computer system displayed the first navigation user interface element in the first manner). In some embodiments, the spatial audio with one or more characteristics corresponding to the position and/or orientation of the first navigation user interface element updated in the second manner include one or more characteristics of the spatial audio described above. Outputting spatial audio to correspond with a changing position and/or the orientation of the first navigation user interface element enhances user interactions with the computer system by providing audio corresponding to the respective position and/or the orientation of the first navigation user interface which provides improved feedback to the user, enhances spatial awareness, and enhances the operability of the computer system and makes the user-computer system interface more efficient.

In some embodiments, while displaying the second navigation user interface element, such as the navigation user interface 754 element in FIG. 7N, the computer system displays a plurality of two-dimensional representations corresponding to one or more physical locations represented by the second navigation user interface element, such as representations of points of interests 746, 748, 750, and 752 in FIG. 7N. In some embodiments, the second navigation user interface element includes one or more characteristics of the second navigation user interface element as described above. For example, the second navigation user interface element is a three-dimensional globe representing the Earth. In some embodiments, the plurality of two-dimensional representations corresponding to one or more physical locations include icons, photos, user interface elements, and/or selectable user interface objects of the one or more physical locations, such as businesses, landmarks, parks, geographic features, and/or other points of interest. In some embodiments, the computer system initially displays the second navigation user interface element with a first rotation, first size, first zoom level, and/or first tilt such that the second navigation user interface element represents an area and/or portion that includes the plurality of two-dimensional representations corresponding to the one or more physical locations. In some embodiments, the computer system displays an indication of a location of a view displayed at a respective location within the second navigation user interface element.

In some embodiments, the computer system detects a third input selecting a respective two-dimensional representation of the plurality of two-dimensional representations, such as hand 718n directed to representation 752 in FIG. 7N. For example, the third input optionally includes a gaze of the user, a contact on a touch-sensitive surface, actuation of a physical input device, a predefined gesture (e.g., pinch gesture or air tap gesture) and/or a voice input from the user corresponding to the respective two-dimensional representation.

In some embodiments, in response to detecting the third input, and in accordance with a determination that the respective two-dimensional representation is a first two-dimensional representation corresponding to a third physical location, the computer system rotates the second navigation user interface element so that a first portion of the second navigation user interface element representing the third physical location is visible in the three-dimensional environment, such as shown by the navigation user interface element 754 in FIG. 7O. For example, the computer system optionally displays the second navigation user interface element with a second rotation, second size, second zoom level, and/or second tilt such that the second navigation user interface element is centered on the first portion that is associated with the third physical location (e.g., without changing the viewpoint of the user of the computer system) from the viewpoint of the user.

In some embodiments, in response to detecting the third input, in accordance with a determination that the respective two-dimensional representation is a second two-dimensional representation corresponding to a fourth physical location, different from the first two-dimensional representation corresponding to the third physical location, the computer system rotates the second navigation user interface element so that a second portion of the second navigation user interface element representing the fourth physical location is visible in the three-dimensional environment, such as the land mass 760 shown by navigation user interface element 754 in FIG. 7O. For example, the computer system optionally displays the second navigation user interface element with a third rotation, third size, third zoom level, and/or third tilt such that the second navigation user interface element is centered on the second portion that is associated with the fourth physical location (e.g., without changing the viewpoint of the user of the computer system) from the viewpoint of the user. Rotating the second navigation user interface element such that a respective physical location is visible in the three-dimensional environment in response to selection of a respective two-dimensional representation that corresponds to the fourth physical location provides an efficient way of viewing a respective portion of the second navigation user interface element corresponding to the respective physical location which simplifies the interaction between the user and the computer system and enhances the operability of the computer system and makes the user-computer system interface more efficient.

In some embodiments, in response to detecting the third input, the computer system updates positions of the plurality of two-dimensional representations in the three-dimensional environment in accordance with rotation of the second navigation user interface element, such as shown by representations of points of interests 746, 748, 750, and 752 in FIG. 7N to the representations of points of interests 746, 748, 750, and 752 in FIG. 7O. For example, rotating the second navigation user interface element so that a respective portion of the second navigation user interface element representing the respective physical location is visible in the three-dimensional environment includes updating the positions of the plurality of two-dimensional representations in the three-dimensional environment even if the respective portion of the second navigation user interface associated with the respective two-dimensional representation ceases to be visible. In some embodiments, the computer system optionally maintains the two-dimensional representations at respective positions and/or orientations (e.g., within a certain range of distances and/or within a certain range of angles) relative to their corresponding locations on the second navigation user interface element while the respective portion of the second navigation user interface element associated with the two-dimensional representations are displayed. In some embodiments, the computer system displays, within the second navigation user interface element, an indicator (e.g., an arrow, icon, or user interface element) indicating to the user to rotate the second navigation user interface element to view/display the plurality of two-dimensional representations that are associated with portions of the second navigation user interface associated that are not visible. Updating the positions of the two-dimensional representations in accordance with the rotation of the second navigation user interface element enables a user to view both the second navigation user interface element and the two-dimensional representations at the same time, without having to zoom to locate the two-dimensional representations, thereby reducing the need for subsequent inputs to display the two-dimensional representations. Providing the two-dimensional representations provides quick and efficient access to relevant content without the need for additional inputs for searching for such content and avoids erroneous inputs related to searching for such content.

In some embodiments, displaying the second navigation user interface element includes displaying a visual indication of a weather condition at a respective physical location represented by the second navigation user interface element at a corresponding location in the three-dimensional environment relative to the second navigation user interface element, such as representation 744 of a weather indicator in FIG. 7N. In some embodiments, the visual indication of a weather condition includes one or more characteristics of the additional content corresponding to the weather condition of the first physical location as described above.

In some embodiments, while displaying the second navigation user interface element including the visual indication of the weather condition, the computer system detects a change to a viewpoint of a user of the computer system in the three-dimensional environment. For example, the change to the viewpoint of the user of the computer system by an amount that is less than a predetermined threshold (e.g., the computer system moves less than 1, 2, 3, 5, 10, 30, or 50 centimeters and/or rotates less than 0.1, 0.5, 1, 2, 3, 4, or 5 degrees). In some embodiments, the computer system detects movement of the computer system. For example, the computer system is a wearable device (e.g., a head-mounted device, a smart watch) and movement of a predefined portion of the user (e.g., the user's head, the user's wrist) causes movement of the computer system.

In some embodiments, in response to detecting the change to the viewpoint of the user, the computer system updates the corresponding location in the three-dimensional environment of the visual indication of the weather condition relative to the second navigation user interface element in a manner to simulate a parallax effect. In some embodiments, updating the corresponding location in the three-dimensional environment of the visual indication of the weather condition relative to the second navigation user interface element in a manner to simulate a parallax effect includes shifting the location of the visual indication of the weather condition in the foreground of the view of the corresponding location by greater distance(s) than the distance(s) by which the visual indication of the weather condition in the background of the view of the corresponding location are shifted. In some embodiments, updating the corresponding location in the three-dimensional environment of the visual indication of the weather condition relative to the second navigation user interface element in a manner to simulate a parallax effect causes one or more portions of the second navigation user interface element that were not previously visible (e.g., because they were blocked by other portions of the second navigation user interface element) to be visible. The above-described manner of updating the first view of the first physical location with a parallax effect provides an intuitive way of updating the first content in accordance with movement of the viewpoint of the user, that corresponds to movement of the viewpoint and allows display of additional content not displayed before the movement, which additionally reduces power usage and improves battery life of the electronic device by enabling the user to use the electronic device more quickly and efficiently (e.g., reducing the number of inputs needed to update the respective content of the navigation user interface when the viewpoint of the user moves).

In some embodiments, displaying the navigation user interface with the second level of immersion corresponding to the second view of the second physical location includes outputting, via one or more output devices in communication with the computer system, spatial audio associated with the second view of the second physical location, such as spatial audio indicator 730 in FIG. 7G. In some embodiments, outputting spatial audio characteristics associated with the second view of the second physical location includes spatial audio that was captured by one or more cameras and/or microphones at the second physical location and optionally from the direction corresponding to the respective direction associated with the second physical location as if emanating from a location relative to the viewpoint of the user of the computer system. In some embodiments, the spatial audio associated with the second view of the second physical location includes one or more characteristics of the spatial audio described above. Outputting spatial audio associated with the second view of the second physical location while displaying the navigation user interface with the second level of immersion corresponding to the second view of the second physical location provides improved feedback to the user, enhances spatial awareness, and enhances the operability of the computer system and makes the user-computer system interface more efficient.

In some embodiments, while displaying the navigation user interface with the second level of immersion corresponding to the second view of the second physical location, the computer system detects, via the one or more input devices, a second input that corresponds to a request to add a virtual object to a respective content of the navigation user interface, such as voice input 724 in FIG. 7D corresponding to a request to add an annotation. For example, the second input optionally includes a gaze of the user, a contact on a touch-sensitive surface, actuation of a physical input device, a predefined gesture (e.g., pinch gesture or air tap gesture) and/or a voice input from the user corresponding to a request to add a virtual object to the respective content. In some embodiments, the virtual object is a representation of a note, tag, or other content item that includes images and/or text generated to be surfaced as the user of the computer system interacts with the respective content.

In some embodiments, in response to detecting the second input, the computer system changes the display of the navigation user interface with the second level of immersion corresponding to the second view of the second physical location to include the virtual object, such as representation 726 of an annotation in FIG. 7E. In some embodiments, the virtual object is displayed concurrently with and/or overlaid on the respective content. In some embodiments, the virtual object is selectable to display the image and/or text associated with the virtual object. In some embodiments, the virtual object is displayed at a location within the respective content corresponding to a point of interest at the second physical location. Concurrently displaying a virtual object with the respective content of the navigation user interface provides the user with user generated information as the user interacts with the respective content (e.g., by automatically surfacing user generated content as the user interacts with the respective content), which simplifies the interaction between the user and the computer system and enhances the operability of the computer system and makes the user-computer system interface more efficient.

In some embodiments, while displaying, via the display generation component, a second three-dimensional environment including pass-through video of the second physical location, the computer system displays, via the display generation component, the virtual object, such as representation 766 of the annotation via an immersive augmented reality 762 in FIG. 7P. In some embodiments, the pass-through video includes one or more characteristics of the pass-through video described above. In some embodiments, the second three-dimensional environment includes one or more characteristics of the three-dimensional environment described above. In some embodiments, a second computer system, different from the computer system, displays the virtual object. In some embodiments, when the computer system determines arrival at the second physical location, the computer systems displays an indication of the virtual object. For example, the computer system optionally displays the indication of the virtual object at a location in the three-dimensional environment similar to or the same as the location that it was placed when adding to the respective content of the navigation user interface. In some embodiments, the indication of the virtual object is selectable to display the second three-dimensional environment including pass-through video of the second physical location and the virtual object. In some embodiments, the second computer system is associated with the same user that is associated with the computer system. In some embodiments, the computer system displays virtual objects generated by other computer systems associated with other users who are affiliated with the user of the computer system and/or the second computer system. Automatically surfacing user generated content associated with the second physical location enables a user to view user generated content while at the second physical location, thereby reducing the need for subsequent inputs to locate the user generated content related to the second physical location which simplifies the interaction between the user and the computer system and enhances the operability of the computer system and makes the user-computer system interface more efficient.

In some embodiments, the computer system displays, via the display generation component, a first navigation user interface element within the three-dimensional environment, wherein the first navigation user interface element represents a third view of the first physical location and an indication of a topography of the first physical location, such as an indication of land mass 760 with an indication of topography in FIG. 7O. In some embodiments, the first navigation user interface element that represents a third view of the first physical location includes one or more characteristics of the first navigation user interface element that represents a third view of the first physical location described above. In some embodiments, the first navigation user interface element and/or the second navigation user interface element includes a three-dimensional topographical map of the first physical location. For example, the indication of the topography of the first physical location optionally includes geometric shapes and/or curved boundaries representing portions of land and elevations. In some embodiments, the first navigation user interface element is displayed in three dimensions and includes a three-dimensional rendering of the topography (e.g., of the ground) of the first physical location. For example, if the first physical location includes a hill, the first navigation user interface element includes a three-dimensional rendering of the hill. In some embodiments, the edges of the first navigation user interface element show cross-sections of the topography of the physical locations corresponding to the edges of the first navigation user interface element. In some embodiments, the first navigation user interface element does not include an indication of topography of the first physical location. Displaying an indication of the topography of the first physical location within the first navigation user interface element provides an efficient way of representing topography the first physical location, which additionally reduces power usage and improves battery life of the computer system by enabling the user to use the computer system more quickly and efficiently.

In some embodiments, the three-dimensional environment is shared with a second computer system, such as computer system 101b in FIG. 7Q and displaying the navigation user interface includes displaying, via the display generation component, a representation of a user of the second computer system at a location in the three-dimensional environment corresponding to a viewpoint of the user of the second computer system, such as selectable travel user interface object 774b in FIG. 7Q. For example, the second computer system has joined a communication session with the computer system. In some embodiments, when joining the communication session, the three-dimensional environment is being shared in the communication session. In some embodiments, the second computer system displays a representation of the user of the computer system at a location in the three-dimensional environment corresponding to the viewpoint of the user of the computer system. In some embodiments, the representation of the user of the second computer system at the location in the three-dimensional environment corresponding to the viewpoint of the user of the second computer system is selectable to update the display of the navigation user interface to correspond to the viewpoint of the user of the second computer system (e.g., to display the view of the three-dimensional environment displayed by the second computer system from the viewpoint of the second user). Displaying the representation of the second user provides an efficient way of indicating to the user the viewpoint of the user of the second computer system, thereby improving communication between the users and enabling the user to use the computer system quickly and efficiently.

It should be understood that the particular order in which the operations in method 800 have been described is merely exemplary and is not intended to indicate that the described order is the only order in which the operations could be performed. One of ordinary skill in the art would recognize various ways to reorder the operations described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with a display generation component and one or more input devices:
displaying, via the display generation component, a navigation user interface within a three-dimensional environment, wherein the navigation user interface includes one or more first travel user interface elements displayed at a first level of immersion corresponding to a first view of a first physical location;
while displaying, via the display generation component, the navigation user interface including the one or more first travel user interface elements, detecting, via the one or more input devices, a first input corresponding to a request to change a level of immersion; and
in response to detecting the first input:
changing the display of the navigation user interface with the first level of immersion corresponding to the first view of the first physical location to a second level of immersion corresponding to the first view of the first physical location, wherein the second level of immersion includes one or more second travel user interface elements, different from the one or more first travel user interface elements, that are selectable to change the display of the navigation user interface from the first view of the first physical location to a second view of a second physical location.

2. The method of claim 1, wherein:
the first view of the first physical location includes a first perspective from a simulated camera; and
the second view of the second physical location is from a second perspective from the simulated camera, different from the first perspective from the simulated camera.

3. The method of claim 1, further comprising:
while displaying the navigation user interface corresponding to the first view of the first physical location, displaying, via the display generation component, a first navigation user interface element within the three-dimensional environment, wherein the first navigation user interface element represents a third view of the first physical location and includes:
an indication of a location of a viewpoint displayed at a respective location within the first navigation user interface element; or
an indication of a field of view displayed at a respective orientation relative to the first navigation user interface element.

4. The method of claim 1, wherein:
the navigation user interface with the first level of immersion occupies a first portion of the three-dimensional environment; and
the navigation user interface with the second level of immersion occupies a second portion of the three-dimensional environment, greater than the first portion of the three-dimensional environment.

5. The method of claim 1, wherein displaying, via the display generation component, the navigation user interface includes displaying the navigation user interface in a manner to simulate the navigation user interface being oriented along a physical object within a physical environment surrounding the computer system.

6. The method of claim 1, further comprising:
while displaying the navigation user interface with the second level of immersion including the one or more second travel user interface elements, detecting, via the one or more input devices, a second input directed to a respective travel user interface element; and in response to detecting the second input:
in accordance with a determination that the respective travel user interface element is a first travel user interface element of the one or more second travel user interface elements, changing the display of the navigation user interface with the second level of immersion corresponding to the first view of the first physical location to the second level of immersion corresponding to a second view of a second physical location; and
in accordance with a determination that the respective travel user interface element is a second travel user interface element of the one or more second travel user interface elements, different from the first travel user interface element, changing the display of the navigation user interface with the second level of immersion corresponding to the first view of the first physical location to the second level of immersion corresponding to a third view of a third physical location, different from the second view of the second physical location.

7. The method of claim 6, wherein displaying the navigation user interface with the second level of immersion corresponding to the second view of a second physical location includes displaying a travel option that, when selected, causes the computer system to display a previous view of a respective physical location, the method further comprising:
while displaying the navigation user interface with the second level of immersion corresponding to the second view of the second physical location, detecting, via the one or more input devices, a third input directed to the travel option; and
in response to detecting the third input, changing the display of the navigation user interface with the second level of immersion corresponding to the second view of the second physical location to correspond to the first view of the first physical location.

8. The method of claim 1, further comprising:
while displaying the navigation user interface corresponding to the first view of the first physical location, displaying, via the display generation component, a first navigation user interface element within the three-dimensional environment, wherein the first navigation user interface element represents a third view of the first physical location and includes an indication of a second computer system at a respective location within the first navigation user interface element corresponding to a current location of the second computer system within the first physical location;
while displaying the first navigation user interface element including the indication of the second computer system within the first navigation user interface element, detecting, via the one or more input devices, a second input directed to the indication of the second computer system; and
in response to detecting the second input, changing the display of the navigation user interface with the second level of immersion corresponding to the first view of the first physical location to correspond to a respective view from the current location of the second computer system.

9. The method of claim 1, further comprising:
while displaying the navigation user interface corresponding to the first view of the first physical location, displaying, via the display generation component, a first navigation user interface element within the three-dimensional environment, wherein the first navigation user interface element represents a third view of the first physical location and includes additional content corresponding to the first physical location.

10. The method of claim 1, further comprising:
while displaying the navigation user interface corresponding to the first view of the first physical location, displaying, via the display generation component, a first navigation user interface element within the three-dimensional environment that represents a third view of the first physical location and includes additional content corresponding to a weather condition at the first physical location.

11. The method of claim 1, further comprising:
while displaying the navigation user interface corresponding to the first view of the first physical location, detecting a second input that corresponds to a request to change a zoom level of the first view of the first physical location; and
in response to detecting the second input:
in accordance with a determination that the request to change the zoom level corresponds to changing the zoom level by a first amount, displaying, via the display generation component, a first navigation user interface element within the three-dimensional environment that represents a third view of the first physical location;
in accordance with a determination that the request to change the zoom level corresponds to changing the zoom level by a second amount, different from the first amount, changing the display of the first navigation user interface element from representing the third view of the first physical location to a fourth view of the first physical location; and
in accordance with a determination that the request to change the zoom level corresponds to changing the zoom level by a third amount, different from the first amount and different from the second amount, displaying, via the display generation component, a second navigation user interface element within the three-dimensional environment, wherein the second navigation user interface element represents a first portion corresponding to the first physical location.

12. The method of claim 11, further comprising:
while displaying the second navigation user interface element including the first portion corresponding to the first physical location, detecting a third input that corresponds to a request to change the zoom level of the first portion; and
in response to detecting the third input:
in accordance with a determination that the request to change the zoom level corresponds to changing the zoom level by a fourth amount, changing the display of the second navigation user interface element from representing the first portion of the first physical location to a second portion of the first physical location;
in accordance with a determination that the request to change the zoom level corresponds to changing the zoom level by a fifth amount, different from the fourth amount, displaying, via the display generation component, the first navigation user interface element within the three-dimensional environment that represents the third view of the first physical location; and
in accordance with a determination that the request to change the zoom level corresponds to changing the zoom level by a sixth amount, different from the fourth amount and different from the fifth amount, displaying a respective content corresponding to the first view of the first physical location.

13. The method of claim 12, further comprising:
while displaying the first navigation user interface element that represents the third view of the first physical location, displaying the first navigation user interface element within a first volume of the three-dimensional environment; and
while displaying the respective content corresponding to the first view of the first physical location, displaying the respective content in a second volume of the three-dimensional environment larger than the first volume in at least one dimension.

14. The method of claim 11, wherein detecting the second input includes detecting a change in a posture of a user of the computer system that satisfies one or more criteria.

15. The method of claim 14, further comprising:
while displaying the first navigation user interface element representing the third view of the first physical location, detecting the change in the posture of the user of the computer system that satisfies the one or more criteria; and
in response to detecting the change in the posture of the user of the computer system that satisfies the one or more criteria:
in accordance with a determination that the change in the posture of the user of the computer system includes a first predetermined pose, scaling the third view of the first physical location by a first amount; and
in accordance with a determination that the change in the posture of the user of the computer system includes a second predetermined pose, different from the first predetermined pose, scaling the third view of the first physical location by a second amount, different from the first amount.

16. The method of claim 14, further comprising:
while displaying the first navigation user interface element representing the third view of the first physical location, detecting the change in the posture of the user of the computer system that satisfies the one or more criteria; and
in response to detecting the change in the posture of the user of the computer system that satisfies the one or more criteria:
in accordance with a determination that the change in the posture of the user of the computer system includes a first predetermined pose, displaying the third view of the first physical location with a first level of detail; and
in accordance with a determination that the change in the posture of the user of the computer system includes a second predetermined pose, different from the first predetermined pose, displaying the third view of the first physical location with a second level of detail, different from the first level of detail.

17. The method of claim 11, wherein detecting the second input that corresponds to a request to zoom includes detecting a change in a viewpoint of a user of the computer system that satisfies one or more criteria; and
in response to detecting the change in the viewpoint of the user of the computer system that satisfies the one or more criteria:
in accordance with a determination that the change in the viewpoint of the user includes movement along a first axis, changing the zoom along a second axis corresponding to the first axis; and in accordance with a determination that the change in the viewpoint of the user includes movement along the second axis, changing the zoom along the first axis corresponding to the second axis.

18. The method of claim 11, further comprising, in response to detecting the second input:
in accordance with a determination that a location of a gaze of a user of the computer system is directed to a first portion of the first navigation user interface element while detecting the second input, changing the zoom level along a first axis in accordance with the first portion of the first navigation user interface element; and
in accordance with a determination that a location of a gaze of a user of the computer system is directed to a second portion of the first navigation user interface element while detecting the second input different from the first portion of the first navigation user interface element, changing the zoom level along a second axis in accordance with the second portion of the first navigation user interface element different from the first axis.

19. The method of claim 11, further comprising:
while displaying the first navigation user interface element representing the third view of the first physical location, detecting a third input that corresponds to a request to update a position and/or an orientation of the first navigation user interface element within the three-dimensional environment; and
in response to detecting the third input, changing the position and/or the orientation of the first navigation user interface element within the three-dimensional environment based on the third input.

20. The method of claim 19, wherein the first navigation user interface element is displayed in a respective volume within the three-dimensional environment and includes a control element that is interactive to rotate the first navigation user interface element.

21. The method of claim 20, further comprising:
while displaying the first navigation user interface element representing the third view of the first physical location and while displaying the control element at a first size, detecting a third input directed to the control element; and
in response to detecting the third input, scaling the respective volume in which the first navigation user interface element is displayed to represent a fourth view of the first physical location in accordance with the third input and scaling the control element to a second size, different from the first size, in accordance with the third input.

22. The method of claim 20, further comprising:
while displaying the first navigation user interface element representing the third view of the first physical location and while displaying the control element at a first size, detecting a third input directed to the first navigation user interface element; and
in response to detecting the third input, scaling the display of the third view of the first physical location to represent a fourth view of the first physical location in accordance with the third input without scaling a view volume associated with the first navigation user interface element.

23. The method of claim 19, further comprising:
while displaying the first navigation user interface element representing the third view of the first physical location, detecting, a fourth input that corresponds to a request to change a zoom level of the third view of the first physical location; and
in response to detecting the fourth input:
in accordance with a determination that the request to change the zoom level corresponds to changing the zoom level to a first level, changing the display of the first navigation user interface element representing the third view of the first physical location to represent a fourth view of the first physical location and outputting, via one or more output devices in communication with the computer system, spatial audio with one or more characteristics corresponding to the fourth view of the first physical location; and
in accordance with a determination that the request to change the zoom level corresponds to changing the zoom level to a second level, different from the first level, changing the display of the first navigation user interface element representing the third view of the first physical location to represent a fifth view of the first physical location, different from the fourth view of the first physical location, and outputting, via the one or more output devices, the spatial audio with the one or more characteristics corresponding to the fifth view of the first physical location.

24. The method of claim 19, further comprising:
while displaying the first navigation user interface element representing the third view of the first physical location and while detecting, via the one or more input devices, a location of a gaze of a user of the computer system on the first navigation user interface element:
in accordance with a determination that the location of the gaze of the user is directed to a first location, outputting, via one or more output devices in communication with the computer system, spatial audio with one or more characteristics corresponding to the first location; and
in accordance with a determination that the location of the gaze of the user is directed to a second location, outputting, via the one or more output devices, spatial audio with one or more characteristics corresponding to the second location.

25. The method of claim 19, further comprising:
while displaying the first navigation user interface representing the third view of the first physical location, detecting, a change to a viewpoint of a user of the computer system in the three-dimensional environment; and
in response to detecting the change to the viewpoint of the user:
in accordance with a determination that the viewpoint of the user is changed from a first viewpoint to a second viewpoint, different from the first viewpoint, changing the display of the first navigation user interface element representing the third view of the first physical location to represent a fourth view of the first physical location and presenting, via one or more output devices in communication with the computer system, spatial audio with one or more characteristics corresponding to the fourth view of the first physical location; and
in accordance with a determination that the viewpoint of the user is changed from the first viewpoint to a third viewpoint, different from the first viewpoint and different from the second viewpoint, changing the display of the first navigation user interface element representing the third view of the first physical location to represent a fifth view of the first physical location, different from the fourth view of the first physical location and presenting, via the one or more output devices, spatial audio with one or more characteristics corresponding to the fifth view of the first physical location, different from the spatial audio with the one or more characteristics corresponding to the fourth view of the first physical location.

26. The method of claim 19, further comprising:
in response to detecting the third input:
in accordance with a determination that the third input corresponds to a request to update the position and/or the orientation of the first navigation user interface element in a first manner, outputting, via one or more output devices in communication with the computer system, spatial audio with one or more characteristics corresponding to the position and/or orientation of the first navigation user interface element updated in the first manner; and
in accordance with a determination that the third input corresponds to a request to update the position and/or the orientation of the first navigation user interface element in a second manner, different from the first manner, outputting, via one or more output devices in communication with the computer system, spatial audio with the one or more characteristics corresponding to the position and/or orientation of the first navigation user interface element updated in the second manner.

27. The method of claim 12, further comprising:
while displaying the second navigation user interface element:
displaying a plurality of two-dimensional representations corresponding to one or more physical locations represented by the second navigation user interface element; detecting a third input selecting a respective two-dimensional representation of the plurality of two-dimensional representations; and
in response to detecting the third input:
in accordance with a determination that the respective two-dimensional representation is a first two-dimensional representation corresponding to a third physical location, rotating the second navigation user interface element so that a first portion of the second navigation user interface element representing the third physical location is visible in the three-dimensional environment; and
in accordance with a determination that the respective two-dimensional representation is a second two-dimensional representation corresponding to a fourth physical location, different from the first two-dimensional representation corresponding to the third physical location, rotating the second navigation user interface element so that a second portion of the second navigation user interface element representing the fourth physical location is visible in the three-dimensional environment.

28. The method of claim 27, further comprising:
in response to detecting the third input, updating positions of the plurality of two-dimensional representations in the three-dimensional environment in accordance with rotation of the second navigation user interface element.

29. The method of claim 12, wherein displaying the second navigation user interface element includes displaying a visual indication of a weather condition at a respective physical location represented by the second navigation user interface element at a corresponding location in the three-dimensional environment relative to the second navigation user interface element, and the method further comprises:
while displaying the second navigation user interface element including the visual indication of the weather condition, detecting a change to a viewpoint of a user of the computer system in the three-dimensional environment; and
in response to detecting the change to the viewpoint of the user, updating the corresponding location in the three-dimensional environment of the visual indication of the weather condition relative to the second navigation user interface element in a manner to simulate a parallax effect.

30. The method of claim 1, wherein displaying the navigation user interface with the second level of immersion corresponding to the second view of the second physical location includes outputting, via one or more output devices in communication with the computer system, spatial audio associated with the second view of the second physical location.

31. The method of claim 1, further comprising:
while displaying the navigation user interface with the second level of immersion corresponding to the second view of the second physical location, detecting, via the one or more input devices, a second input that corresponds to a request to add a virtual object to a respective content of the navigation user interface; and
in response to detecting the second input, changing the display of the navigation user interface with the second level of immersion corresponding to the second view of the second physical location to include the virtual object.

32. The method of claim 11, further comprising:
while displaying, via the display generation component, a second three-dimensional environment including pass-through video of the second physical location, displaying, via the display generation component, the virtual object.

33. The method of claim 1, wherein the three-dimensional environment is shared with a second computer system and displaying the navigation user interface includes displaying, via the display generation component, a representation of a user of the second computer system at a location in the three-dimensional environment corresponding to a viewpoint of the user of the second computer system.

34. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
displaying, via a display generation component, a navigation user interface within a three-dimensional environment, wherein the navigation user interface includes one or more first travel user interface elements displayed at a first level of immersion corresponding to a first view of a first physical location;
while displaying, via the display generation component, the navigation user interface including the one or more first travel user interface elements, detecting, via one or more input devices, a first input corresponding to a request to change a level of immersion; and
in response to detecting the first input:
changing the display of the navigation user interface with the first level of immersion corresponding to the first view of the first physical location to a second level of immersion corresponding to the first view of the first physical location, wherein the second level of immersion includes one or more second travel user interface elements, different from the one or more first travel user interface elements, that are selectable to change the display of the navigation user interface from the first view of the first physical location to a second view of a second physical location.

35. A non-transitory computer readable storage medium storing one or more programs, the one or more programs comprising instructions, which when executed by one or more processors of a computer system that is in communication with a display generation component and one or more input devices, cause the computer system to perform a method comprising:
displaying, via a display generation component, a navigation user interface within a three-dimensional environment, wherein the navigation user interface includes one or more first travel user interface elements displayed at a first level of immersion corresponding to a first view of a first physical location;
while displaying, via the display generation component, the navigation user interface including the one or more first travel user interface elements, detecting, via one or more input devices, a first input corresponding to a request to change a level of immersion; and
in response to detecting the first input:
changing the display of the navigation user interface with the first level of immersion corresponding to the first view of the first physical location to a second level of immersion corresponding to the first view of the first physical location, wherein the second level of immersion includes one or more second travel user interface elements, different from the one or more first travel user interface elements, that are selectable to change the display of the navigation user interface from the first view of the first physical location to a second view of a second physical location.
